(19) United States
(12) Patent Application Publication
(10) Pub. No.: US 2014/0254007 A1
(43) Pub. Date: Sep. 11, 2014

(54) Parallax Shutter Barrier For Temporally Interlaced Autostereoscopic Three Dimensional (3D) Display Apparatus

(71) Applicant: QUALCOMM MEMS TECHNOLOGIES, INC. (QMT), San Diego, CA (US)

(72) Inventors: Jian Ma, Carlsbad, CA (US); John Hong, San Clemente, CA (US)

(73) Assignee: QUALCOMM MEMS TECHNOLOGIES, INC. (QMT), San Diego, CA (US)

(21) Appl. No.: 13/794,249

(22) Filed: Mar. 11, 2013

(51) Int. Cl. G02B 27/22

(52) U.S. Cl. CPC G02B 27/2214
USPC 359/464

(57) ABSTRACT

This disclosure provides systems, methods and apparatus related to displaying 3D images. In one aspect, an apparatus includes an array of display elements and a plurality of parallax barrier shutters. Each parallax barrier shutter corresponds to one of the display elements and is configured to be driven into a first state in which an angular distribution of light passing the parallax barrier shutter from the corresponding display element is weighted towards a first side of the apparatus or a second state in which the angular distribution of light passing the parallax barrier shutter from the corresponding display element is weighted towards a second side of the apparatus opposite the first side.

### TECHNICAL FIELD

This disclosure relates to the field of electromechanical systems (EMS), and in particular, to a parallax shutter barrier for use in a display apparatus.

### DESCRIPTION OF THE RELATED TECHNOLOGY

An image is perceived in three-dimensions by creating or enhancing the illusion of depth in an image. This is done by presenting two offset images separately to the left and right eyes of a viewer. Traditionally, 3D viewing has been achieved by providing a viewer with glasses that, through varying techniques, enable each of the viewers' eyes to view a slightly different image. For example, the images for each eye were formed using light of different polarity or of different colors, and glasses worn by the viewer included polarization or color filters, accordingly. The difference between the two images resulted in a perception of depth, or a perceived third dimension.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus including an array of display elements and a plurality of parallax barrier shutters. Each parallax barrier shutter corresponds to one of the display elements and is configured to be driven into a first state in which an angular distribution of light passing the parallax barrier shutter from the corresponding display element is weighted towards a first side of the apparatus or a second state in which the angular distribution of light passing the parallax barrier shutter from the corresponding display element is weighted towards a second side of the apparatus opposite the first side.

In some implementations, the display elements have electromechanical structures that are substantially identical to electromechanical structures of the parallax barrier shutters. In some implementations, the display elements have structures that are substantially different from structures of the parallax barrier shutters. In some implementations, each of the parallax barrier shutters includes an electromechanical system (EMS) shutter.

In some implementations, a controller that is configured to cause the EMS shutter of a respective parallax barrier shutter to be driven into the first state by causing a first voltage to be applied to a first actuator coupled to the parallax barrier shutter and to be driven into the second state by causing a second voltage to be applied to a second actuator coupled to the parallax barrier shutter. In some implementations, a controller is configured to drive, at a first time, a parallax barrier shutter of the plurality of parallax barrier shutters to the first state in conjunction with providing a corresponding display element image data corresponding to a first eye image. The controller is also configured to drive, at a second time, the parallax barrier shutter to the second state in conjunction with providing the corresponding display element image data corresponding to a second eye image.

In some implementations, the plurality of parallax barrier shutters are coupled to a common voltage source such that, at a first time, all of the plurality of parallax barrier shutters are driven to the first state in conjunction with providing the display elements image data corresponding to a first eye image and at a second time, all of the plurality of parallax barrier shutters are driven to the second state in conjunction with providing the display elements image data corresponding to a second eye image.

In some implementations, a controller is configured to independently drive a first set of the parallax barrier shutters to the first state in conjunction with providing a corresponding set of display elements image data corresponding to a portion of a first eye image and configured to independently drive a second set of the parallax barrier shutters to the second state in conjunction with providing a corresponding set of display elements image data corresponding to a portion of a second eye image.

In some implementations, a rear substrate is positioned between a backlight and the parallax barrier shutters. The rear substrate has a light blocking layer, which defines a plurality of rear apertures. Each of the rear apertures corresponds to one of the parallax barrier shutters. The parallax barrier shutters further include light blocking portions, which overlap a first side of the corresponding rear apertures when the parallax barrier shutters are in a first state and overlap a second side opposite the first side of the corresponding rear apertures when the parallax barrier shutters are in a second state.

In some implementations, the light blocking portions of the parallax barrier shutters overlap the first side of the corresponding rear apertures by a predetermined distance when the parallax barrier shutters are in the first state. The light blocking portions of the parallax barrier shutters overlap the second side of the corresponding rear apertures by the same predetermined distance when the parallax barrier shutters are in the second state.

In some implementations, the display elements are formed on the rear substrate and the parallax barrier shutters are formed on a front substrate supported over the rear substrate. In some implementations, the display elements are formed on a modulator substrate supported over a rear substrate that is positioned between a backlight and the modulator substrate. The rear substrate has rear apertures formed thereon. The parallax barrier shutters are formed on a front substrate supported over the modulator substrate.

In some implementations, the parallax barrier shutters are coated with a layer of anti-reflective coating. In some implementations, the parallax barrier shutters include light blocking portions and parallax barrier shutters apertures formed therethrough. The light blocking portions of a first parallax barrier shutter extend from the parallax barrier shutter aperture of the first parallax barrier shutter to about half the distance between the first parallax barrier shutter aperture and a second parallax barrier shutter aperture of a neighboring parallax barrier shutter.

In some implementations, the apparatus includes a display including the array of display elements, a processor that is configured to process image data and a memory device that is configured to communicate with the processor. In some implementations, the apparatus includes a driver circuit configured to send at least one signal to the display and the processor is further configured to send at least a portion of the image data to the driver circuit. In some implementations, the apparatus includes an image source module configured to send the image data to the processor. In some such implementations, the image source module includes at least one of a receiver, transceiver, and transmitter. In some implementations, the apparatus includes an input device configured to receive input data and to communicate the input data to the processor.

In some implementations, the display elements include EMS display elements. In some implementations, the display elements include microelectromechanical system (MEMS) display elements. In some implementations, the display elements include light modulators.

One innovative aspect of the subject matter described in this disclosure can be implemented in an apparatus that includes an array of display elements and means for limiting the angular distribution of light corresponding to one of the display elements. The means for limiting the angular distribution of light is configured to be driven into a first state in which an angular distribution of light passing the means for limiting the angular distribution of light from the corresponding display element is weighted towards a first side of the apparatus or a second state in which the angular distribution of light passing the means for limiting the angular distribution of light from the corresponding display element is weighted towards a second side of the apparatus opposite the first side.

In some implementations, the apparatus includes means for driving the means for limiting the angular distribution of light into the first state by causing a first voltage to be applied to a first actuation means coupled to the means for limiting the angular distribution of light and for driving the means for limiting the angular distribution of light into the second state by causing a second voltage to be applied to a second actuation means coupled to the means for limiting the angular distribution of light.

In some implementations, the apparatus includes means for driving, at a first time, the means for limiting the angular distribution of light to the first state in conjunction with providing a corresponding display element image data corresponding to a first eye image and for driving, at a second time, the means for limiting the angular distribution of light to the second state in conjunction with providing the corresponding display element image data corresponding to a second eye image.

In some implementations, the means for limiting the angular distribution of light is coupled to a common voltage source such that, at a first time, the means for limiting the angular distribution of light are driven to the first state in conjunction with providing the display elements image data corresponding to a first eye image and at a second time, the means for limiting the angular distribution of light are driven to the second state in conjunction with providing the display elements image data corresponding to a second eye image.

In some implementations, the apparatus includes means for independently driving a first set of the means for limiting the angular distribution of light to the first state in conjunction with providing a corresponding set of display elements image data corresponding to a portion of a first eye image and for independently driving a second set of the means for limiting the angular distribution of light to the second state in conjunction with providing a corresponding set of display elements image data corresponding to a portion of a second eye image.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays (LCDs), organic light emitting diode (OLED) displays, electrophoretic displays, and field emission displays, as well as to other non-display MEMS devices, such as MEMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows an example schematic diagram of a direct-view MEMS-based display apparatus.

FIG. 1B shows an example block diagram of a host device.

FIG. 2 shows an example perspective view of an illustrative shutter-based light modulator.

FIG. 3A shows an example schematic diagram of a control matrix.

FIG. 3B shows an example perspective view of an array of shutter-based light modulators connected to the control matrix of FIG. 3A.

FIGS. 4A and 4B show example views of a dual actuator shutter assembly.

FIG. 5 shows an example cross sectional view of a display apparatus incorporating shutter-based light modulators.

FIG. 6 shows an example cross sectional view of a light modulator substrate and an aperture plate for use in a MEMS-down configuration of a display.

FIG. 7A shows an example plan view of a display apparatus that generates left eye images and a right eye images for viewing by a viewer.

FIG. 8 shows an example portion of a display 802 at two points in time.

FIG. 9A shows a cross-sectional view of an example display.

FIG. 9B shows an example cross-sectional view of the display.

FIG. 9C shows an example top view of a portion of the display as shown in FIG. 9A.

FIG. 9D shows another example top view of a portion of the display as shown in FIG. 9A.

FIG. 9E shows an example cross-sectional view of another example display.

FIG. 9F shows an example top view of a portion of the display as shown in FIG. 9E.

FIG. 10A shows an example cross-sectional view of the display of FIG. 9A.

FIG. 10B shows an example top view of a portion of the display as shown in FIG. 10A.

FIG. 11A shows an example portion of a display at two points in time.

FIG. 11B shows an example portion of a display at two points in time.

FIG. 12A shows a cross-sectional view of an example display.

FIG. 12B shows an example top view of a portion of the display as shown in FIG. 12A.

FIG. 13A shows a cross-sectional view of an example display.

FIG. 13B shows an example top view of a portion of the display as shown in FIG. 12A.

FIG. 14 shows a cross-sectional view of another example display.

FIG. 15 shows an example flow diagram of a temporal multiplexing display process by which a controller can display 3D images.

FIG. 16 shows an example flow diagram of a display process for displaying images.

FIGS. 17A and 17B are examples of system block diagrams illustrating a display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (for example, e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Display apparatus including parallax barrier shutters can be used to achieve 3D image generation without requiring a viewer to wear glasses. To generate a 3D image, a display apparatus can be caused to separately form a left eye image and a right eye image that can be different from the left eye image. A left eye image is an image formed from light having an angular distribution weighted more heavily towards the left side of the display, and thus towards the left eye of a viewer. Conversely, a right eye image is an image formed from light having an angular distribution weighted more heavily towards the right side of the display, and thus towards the right eye of a viewer. As used herein, a left eye image or a right eye image may refer to a full image frame or an image subframe output as part of a time-division multiplexing display process. The parallax barrier shutters referred to above limit the angular distribution of light output by a display, alternately to the left and then to the right, such that the display can form separate left eye and right eye images as described above.

In some implementations, the display apparatus can include a plurality of display elements that correspond to a plurality of rear apertures formed through a light reflecting layer of an underlying rear substrate. The display apparatus also includes a plurality of parallax barrier shutters that are formed on a front substrate. Each of the parallax barrier shutters corresponds to one of the plurality of display elements. A parallax barrier shutter includes a light blocking portion through which a parallax barrier shutter aperture is formed. The parallax barrier shutter can be driven between a left eye image state and a right eye image state. When the parallax barrier shutter is in the left eye image state, the center of the parallax barrier shutter aperture is offset to the left of the underlying rear aperture such that the light blocking portion of the parallax barrier shutter overlaps a right side of the rear aperture. Some of the light from the backlight that passes through the rear aperture and the underlying display element is blocked by the light blocking portion of the parallax barrier shutter overlapping the right side of the rear shutter. The remaining light from the backlight that passes through the parallax barrier shutter aperture has an angular distribution weighted more heavily towards the left eye of a viewer. Conversely, when the parallax barrier shutter is in the right eye image state, the center of the parallax barrier shutter aperture is offset to the right of the underlying rear aperture such that the light blocking portion of the parallax barrier shutter overlaps a left side of the rear aperture. Some of the light from the backlight that passes through the rear aperture and the underlying display element is blocked by the light blocking portion of the parallax barrier shutter overlapping the left side of the rear shutter. The remaining light from the backlight that passes through the parallax barrier shutter aperture has an angular distribution weighted more heavily towards the right eye of the viewer.

In some implementations, the parallax barrier shutters are switched collectively. In this implementation, all the shutter elements collectively are controlled by a single control signal that is synchronized with the display content. As such, the parallax barrier shutters can all be driven to one of the left eye image state or right eye image state at the same time. In this way, the display can output either a left eye image or a right eye image depending on the state of the parallax barrier shutters. In some such implementations, the display is configured to display a 3D image by temporally multiplexing left and right eye images on the display using the same parallax barrier shutters of the display.

In some implementations, the parallax barrier shutters are independently controlled. As such, at any given time, one or more of the parallax barrier shutters can be driven to one of the left eye image state or right eye image state, while the remaining parallax barrier shutters can be driven to the other of the left eye image state or the right eye image state. In some such implementations, the display is configured to display a 3D image by spatially multiplexing left and right eye images on the display. In a first subframe, one or more of the parallax barrier shutters can be driven to one of the left eye image state or right eye image state, while the remaining parallax barrier shutters can be driven to the other of the left eye image state or the right eye image state. In a subsequent subframe, the parallax barrier shutters driven to the left eye image state are driven to the right eye image state, while the parallax barrier shutters previously driven to the right eye image state are driven to the left eye image state. The display is configured to provide left eye image data to the display elements corresponding to the parallax barrier shutters driven to the left eye image state and right eye image data to the display elements corresponding to the parallax barrier shutters driven to the right eye image state.

In some implementations, the parallax barrier shutter assemblies may be structurally identical to the underlying display shutter assemblies to which they correspond. In some other implementations, the display element shutter assemblies may differ from the parallax barrier shutter assemblies. In some other implementations, alternative display element architectures, instead of shutter assemblies, may be employed with the array of parallax barrier shutter assemblies.

In some implementations, the display shutter assemblies can be formed on the rear substrate instead of on a modulator substrate. In some such implementations, the display can include only two substrates, namely the rear substrate on which display shutter assemblies are formed and the front substrate on which the parallax barrier shutter assemblies are formed.

Particular implementations of the subject matter described in this disclosure can be implemented to realize one or more of the following potential advantages. Displaying a left eye image in which the light emitted from the display pixel has an angular distribution weighted more heavily towards the left eye along with a right eye image in which the light emitted from the display pixel has an angular distribution weighted more heavily towards the right eye of a viewer can create the perception of a 3D image when the display content of the left eye image and the right eye image is properly formed. Using the techniques described herein, display apparatus can generate left eye images and right eye images to form 3D images that can be perceived by viewers without having to use special glasses.

By incorporating parallax barrier shutters that are coated with a layer of light absorbing material on the front surface, the parallax barrier shutters can collectively form an light absorbing layer, obviating the need for a separate light absorbing layer formed on the front substrate. Forming a separate light absorbing layer on the front substrate involves additional manufacturing steps, which can increase the cost and complexity of the manufacturing process. Such additional apertures may also limit the viewing angle of the display. In some implementations, the parallax barrier shutters can have extended light blocking portions. The extended light blocking portions can reduce the amount of ambient light that is reflected off surfaces within the display other than the light blocking portions. In addition, the light blocking portions can also reduce the amount of light leakage from within the display. In this way, the contrast ratio of the display is improved.

In some implementations in which the parallax barrier shutters can be independently controlled, the display has more flexibility in displaying images. The additional flexibility can allow the display to selectively produce 3D images using either spatial, temporal, or spatial temporal multiplexing based on image content characteristics or based on instructions from a host device. Formation of 3D images using temporal multiplexing has the advantage of maintaining the same display resolution as used to form two dimensional (2D) images. Display apparatus disclosed herein can dynamically switch between display of 2D and 3D images.

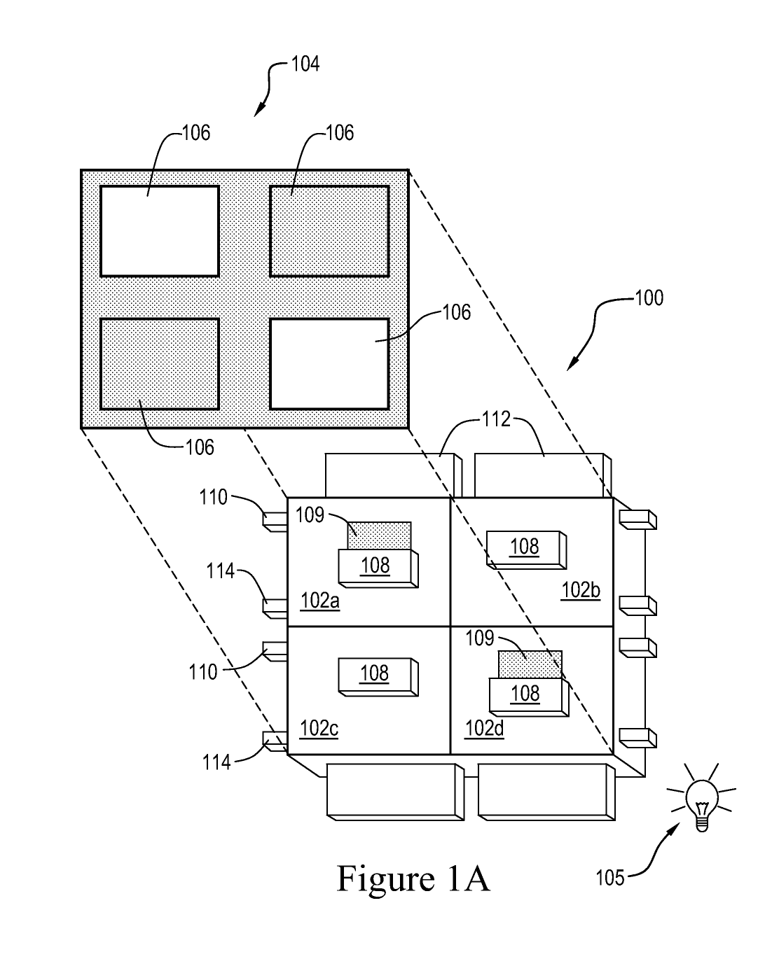

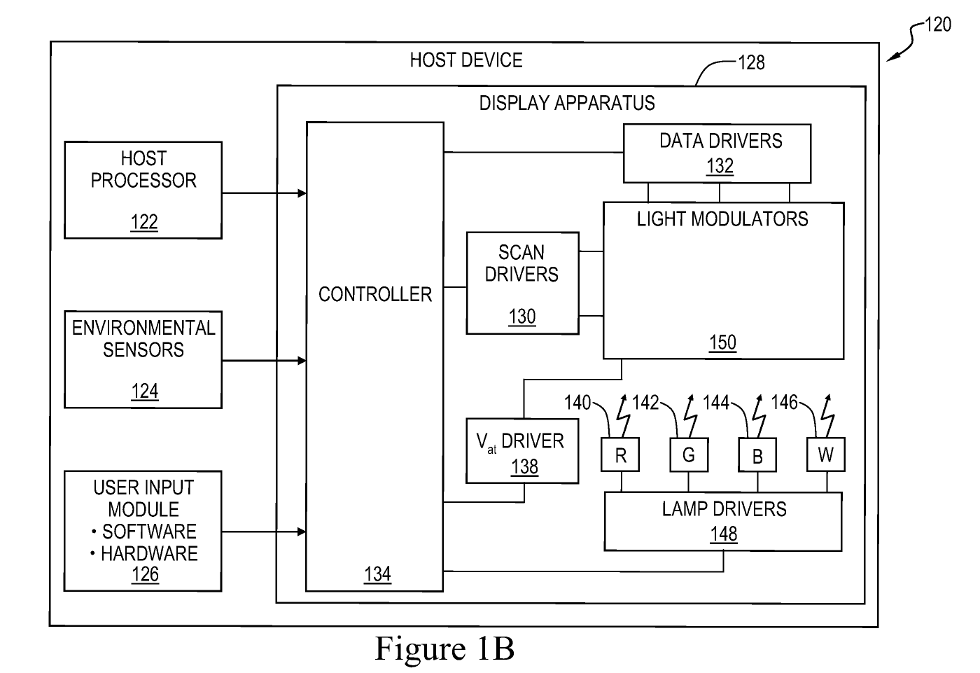

FIG. 1A shows a schematic diagram of an example direct-view MEMS-based display apparatus 100. The display apparatus 100 includes a plurality of light modulators 102a-102d (generally “light modulators 102”) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide luminance level in an image 104. With respect to an image, a “pixel” corresponds to the smallest picture element defined by the resolution of image. With respect to structural components of the display apparatus 100, the term “pixel” refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or “backlight” so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 can include a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (for example, interconnects 110, 112 and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{WE}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, for example, transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows a block diagram of an example host device 120 (i.e., cell phone, smart phone, PDA, MP3 player, tablet, e-reader, netbook, notebook, etc.). The host device 120 includes a display apparatus 128, a host processor 122, environmental sensors 124, a user input module 126, and a power source.

The display apparatus 128 includes a plurality of scan drivers 130 (also referred to as “write enabling voltage sources”), a plurality of data drivers 132 (also referred to as “data voltage sources”), a controller 134, common drivers 138, lamps 140-146, lamp drivers 148 and an array 150 of display elements, such as the light modulators 102 shown in FIG. 1A. The scan drivers 130 apply write enabling voltages to scan-line interconnects 110. The data drivers 132 apply data voltages to the data interconnects 112.

In some implementations of the display apparatus, the data drivers 132 are configured to provide analog data voltages to the array 150 of display elements, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are configured to apply only a reduced set of 2, 3 or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the “controller 134”). The controller sends data to the data drivers 132 in a mostly serial fashion, organized in sequences, which in some implementations may be predetermined, grouped by rows and by image frames. The data drivers 132 can include series to parallel data converters, level shifting, and for some applications digital to analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 114. In some other implementations, the common drivers 138, following commands from the controller 134, issue voltage pulses or signals to the array 150 of display elements, for instance global actuation pulses which are capable of driving and/or initiating simultaneous actuation of all display elements in multiple rows and columns of the array 150.

All of the drivers (for example, scan drivers 130, data drivers 132 and common drivers 138) for different display functions are time-synchronized by the controller 134. Timing commands from the controller coordinate the illumination of red, green and blue and white lamps (140, 142, 144 and 146 respectively) via lamp drivers 148, the write-enabling and sequencing of specific rows within the array 150 of display elements, the output of voltages from the data drivers 132, and the output of voltages that provide for display element actuation. In some implementations, the lamps are light emitting diodes (LEDs).

The controller 134 determines the sequencing or addressing scheme by which each of the shutters 108 can be re-set to the illumination levels appropriate to a new image 104. New images 104 can be set at periodic intervals. For instance, for video displays, the color images 104 or frames of video are refreshed at frequencies ranging from 10 to 300 Hertz (Hz). In some implementations the setting of an image frame to the array 150 is synchronized with the illumination of the lamps 140, 142, 144 and 146 such that alternate image frames are illuminated with an alternating series of colors, such as red, green, and blue. The image frames for each respective color is referred to as a color subframe. In this method, referred to as the field sequential color method, if the color subframes are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

In some implementations, where the display apparatus 100 is designed for the digital switching of shutters 108 between open and closed states, the controller 134 forms an image by the method of time division gray scale, as previously described. In some other implementations, the display apparatus 100 can provide gray scale through the use of multiple shutters 108 per pixel.

In some implementations, the data for an image state 104 is loaded by the controller 134 to the display element array 150 by a sequential addressing of individual rows, also referred to as scan lines. For each row or scan line in the sequence, the scan driver 130 applies a write-enable voltage to the write enable interconnect 110 for that row of the array 150, and subsequently the data driver 132 supplies data voltages, corresponding to desired shutter states, for each column in the selected row. This process repeats until data has been loaded for all rows in the array 150. In some implementations, the sequence of selected rows for data loading is linear, proceeding from top to bottom in the array 150. In some other implementations, the sequence of selected rows is pseudo-randomized, in order to minimize visual artifacts. And in some other implementations the sequencing is organized by blocks, where, for a block, the data for only a certain fraction of the image state 104 is loaded to the array 150, for instance by addressing only every 5^{th} row of the array 150 in sequence.

In some implementations, the process for loading image data to the array 150 is separated in time from the process of actuating the display elements in the array 150. In these implementations, the display element array 150 may include data memory elements for each display element in the array 150 and the control matrix may include a global actuation interconnect for carrying trigger signals, from common driver 138, to initiate simultaneous actuation of shutters 108 according to data stored in the memory elements.

In alternative implementations, the array 150 of display elements and the control matrix that controls the display elements may be arranged in configurations other than rectangular rows and columns. For example, the display elements can be arranged in hexagonal arrays or curvilinear rows and columns. In general, as used herein, the term scan-line shall refer to any plurality of display elements that share a write-enabling interconnect.

The host processor 122 generally controls the operations of the host. For example, the host processor 122 may be a general or special purpose processor for controlling a portable electronic device. With respect to the display apparatus 128, included within the host device 120, the host processor 122 outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

The user input module 126 conveys the personal preferences of the user to the controller 134, either directly, or via the host processor 122. In some implementations, the user input module 126 is controlled by software in which the user programs personal preferences such as “deeper color,” “better contrast,” “lower power,” “increased brightness,” “sports,” “live action,” or “animation.” In some other implementations, these preferences are input to the host using hardware, such as a switch or dial. The plurality of data inputs to the controller 134 direct the controller to provide data to the various drivers 130, 132, 138 and 148 which correspond to optimal imaging characteristics.

An environmental sensor module 124 also can be included as part of the host device 120. The environmental sensor module 124 receives data about the ambient environment, such as temperature and or ambient lighting conditions. The sensor module 124 can be programmed to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

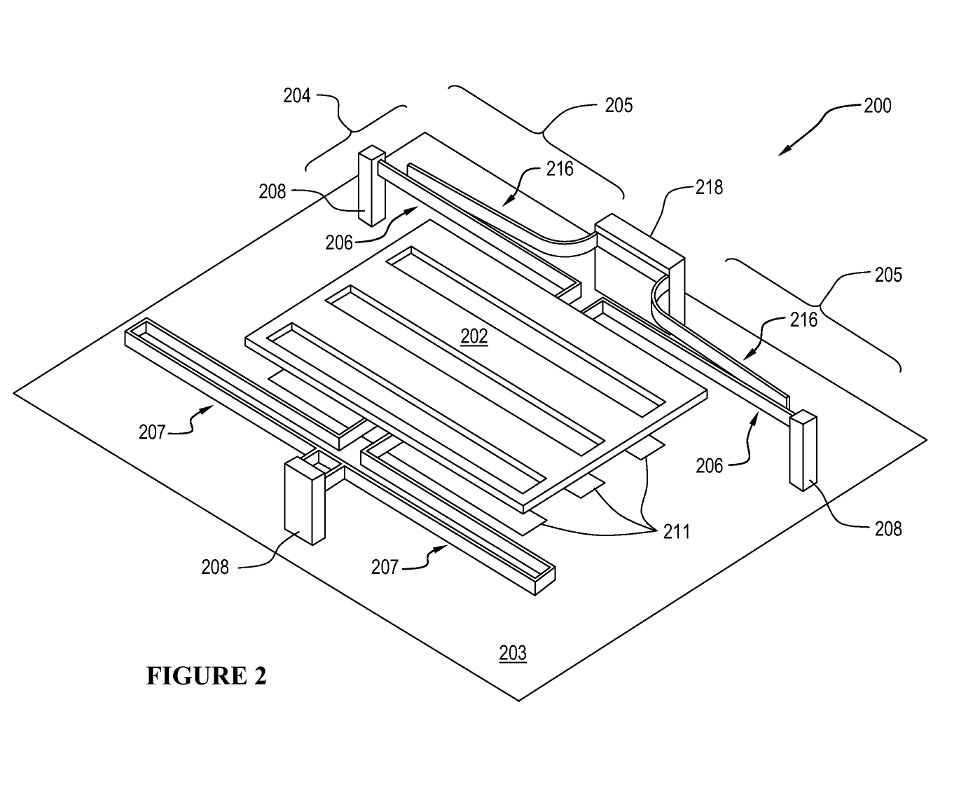

FIG. 2 shows a perspective view of an example shutter-based light modulator 200. The shutter-based light modulator 200 is suitable for incorporation into the direct-view MEMS-based display apparatus 100 of FIG. 1A. The light modulator 200 includes a shutter 202 coupled to an actuator 204. The actuator 204 can be formed from two separate compliant electrode beam actuators 205 (the “actuators 205”). The shutter 202 couples on one side to the actuators 205. The actuators 205 move the shutter 202 transversely over a substrate 203 in a plane of motion which is substantially parallel to the substrate 203. The opposite side of the shutter 202 couples to a spring 207 which provides a restoring force opposing the forces exerted by the actuator 204.

Each actuator 205 includes a compliant load beam 206 connecting the shutter 202 to a load anchor 208. The load anchors 208 along with the compliant load beams 206 serve as mechanical supports, keeping the shutter 202 suspended proximate to the substrate 203. The substrate 203 includes one or more aperture holes 211 for admitting the passage of light. The load anchors 208 physically connect the compliant load beams 206 and the shutter 202 to the substrate 203 and electrically connect the load beams 206 to a bias voltage, in some instances, ground.

If the substrate is opaque, such as silicon, then aperture holes 211 are formed in the substrate by etching an array of holes through the substrate 203. If the substrate 203 is transparent, such as glass or plastic, then the aperture holes 211 are formed in a layer of light-blocking material deposited on the substrate 203. The aperture holes 211 can be generally circular, elliptical, polygonal, serpentine, or irregular in shape.

Each actuator 204 also includes a compliant drive beam 216 positioned adjacent to each load beam 206. The drive beams 216 couple at one end to a drive beam anchor 218 shared between the drive beams 216. The other end of each drive beam 216 is free to move. Each drive beam 216 is curved such that it is closest to the load beam 206 near the free end of the drive beam 216 and the anchored end of the load beam 206.

In operation, a display apparatus incorporating the light modulator 200 applies an electric potential to the drive beams 216 via the drive beam anchor 218. A second electric potential may be applied to the load beams 206. The resulting potential difference between the drive beams 216 and the load beams 206 pulls the free ends of the drive beams 216 towards the anchored ends of the load beams 206, and pulls the shutter ends of the load beams 206 toward the anchored ends of the drive beams 216, thereby driving the shutter 202 transversely toward the drive beam anchor 218. The compliant load beams 206 act as springs, such that when the voltage across the beams 206 and 216 potential is removed, the load beams 206 push the shutter 202 back into its initial position, releasing the stress stored in the load beams 206.

A light modulator, such as the light modulator 200, incorporates a passive restoring force, such as a spring, for returning a shutter to its rest position after voltages have been removed. Other shutter assemblies can incorporate a dual set of “open” and “closed” actuators and a separate set of “open” and “closed” electrodes for moving the shutter into either an open or a closed state.

There are a variety of methods by which an array of shutters and apertures can be controlled via a control matrix to produce images, in many cases moving images, with appropriate luminance levels. In some cases, control is accomplished by means of a passive matrix array of row and column interconnects connected to driver circuits on the periphery of the display. In other cases it is appropriate to include switching and/or data storage elements within each pixel of the array (the so-called active matrix) to improve the speed, the luminance level and/or the power dissipation performance of the display.

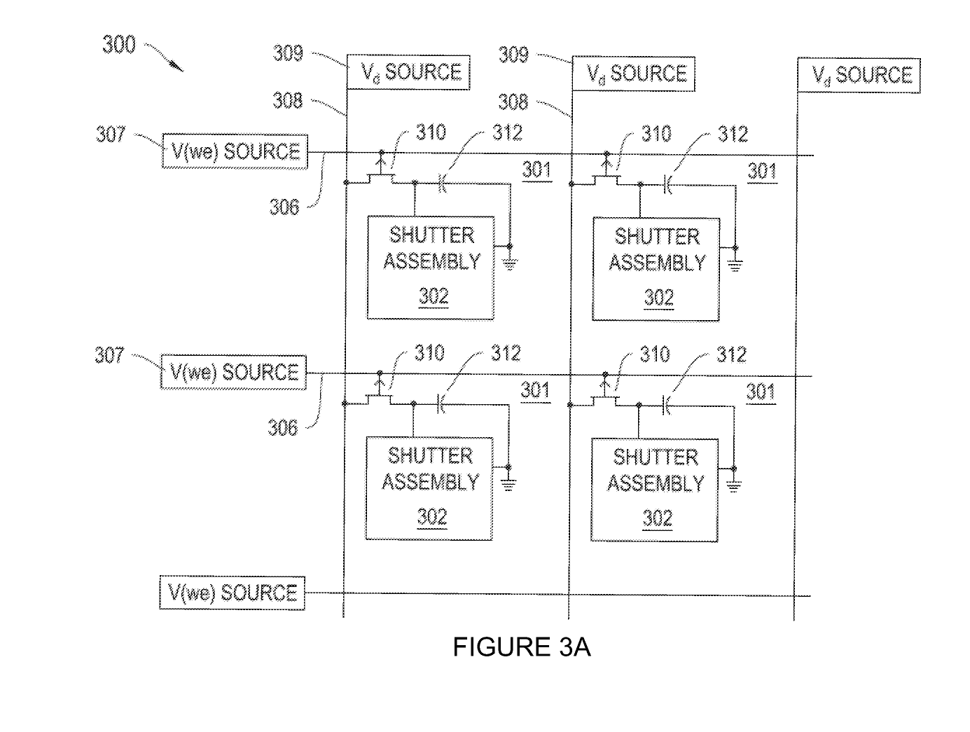

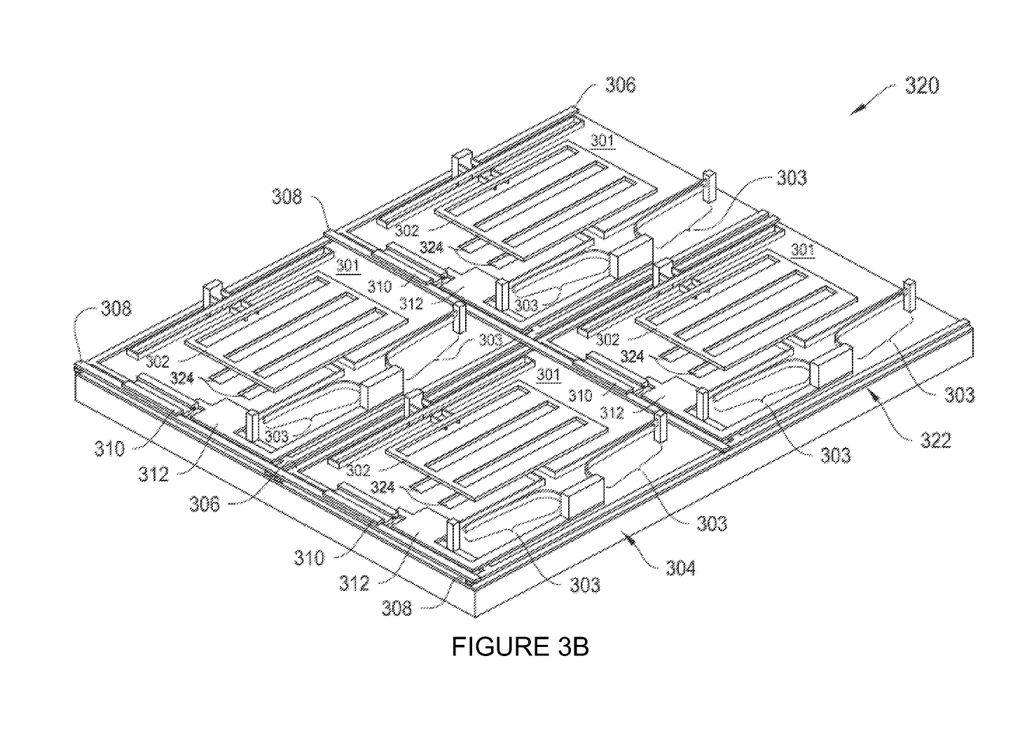

FIG. 3A shows a schematic diagram of an example control matrix 300. The control matrix 300 is suitable for controlling the light modulators incorporated into the MEMS-based display apparatus 100 of FIG. 1A. FIG. 3B shows a perspective view of an example array 320 of shutter-based light modulators connected to the control matrix 300 of FIG. 3A. The control matrix 300 may address an array of pixels 320 (the “array 320”). Each pixel 301 can include an elastic shutter assembly 302, such as the shutter assembly 200 of FIG. 2, controlled by an actuator 303. Each pixel also can include an aperture layer 322 that includes apertures 324.

The control matrix 300 is fabricated as a diffused or thin-film-deposited electrical circuit on the surface of a substrate 304 on which the shutter assemblies 302 are formed. The control matrix 300 includes a scan-line interconnect 306 for each row of pixels 301 in the control matrix 300 and a data-interconnect 308 for each column of pixels 301 in the control matrix 300. Each scan-line interconnect 306 electrically connects a write-enabling voltage source 307 to the pixels 301 in a corresponding row of pixels 301. Each data interconnect 308 electrically connects a data voltage source 309 (“V_{d} source”) to the pixels 301 in a corresponding column of pixels. In the control matrix 300, the V_{d} source 309 provides the majority of the energy to be used for actuation of the shutter assemblies 302. Thus, the data voltage source, V_{d} source 309, also serves as an actuation voltage source.

Referring to FIGS. 3A and 3B, for each pixel 301 or for each shutter assembly 302 in the array of pixels 320, the control matrix 300 includes a transistor 310 and a capacitor 312. The gate of each transistor 310 is electrically connected to the scan-line interconnect 306 of the row in the array 320 in which the pixel 301 is located. The source of each transistor 310 is electrically connected to its corresponding data interconnect 308. The actuators 303 of each shutter assembly 302 include two electrodes. The drain of each transistor 310 is electrically connected in parallel to one electrode of the corresponding capacitor 312 and to one of the electrodes of the corresponding actuator 303. The other electrode of the capacitor 312 and the other electrode of the actuator 303 in shutter assembly 302 are connected to a common or ground potential. In alternate implementations, the transistors 310 can be replaced with semiconductor diodes and or metal-insulator-metal sandwich type switching elements.

In operation, to form an image, the control matrix 300 write-enables each row in the array 320 in a sequence by applying V_{we} to each scan-line interconnect 306 in turn. For a write-enabled row, the application of V_{we} to the gates of the transistors 310 of the pixels 301 in the row allows the flow of current through the data interconnects 308 through the transistors 310 to apply a potential to the actuator 303 of the shutter assembly 302. While the row is write-enabled, data voltages V_{d} are selectively applied to the data interconnects 308. In implementations providing analog gray scale, the data voltage applied to each data interconnect 308 is varied in relation to the desired brightness of the pixel 301 located at the intersection of the write-enabled scan-line interconnect 306 and the data interconnect 308. In implementations providing digital control schemes, the data voltage is selected to be either a relatively low magnitude voltage (i.e., a voltage near ground) or to meet or exceed Vₐₜ (the actuation threshold voltage). In response to the application of Vₐₜ to a data interconnect 308, the actuator 303 in the corresponding shutter assembly actuates, opening the shutter in that shutter assembly 302. The voltage applied to the data interconnect 308 remains stored in the capacitor 312 of the pixel 301 even after the control matrix 300 ceases to apply V_{we} to a row. Therefore, the voltage V_{we} does not have to wait and hold on a row for times long enough for the shutter assembly 302 to actuate; such actuation can proceed after the write-enabling voltage has been removed from the row. The capacitors 312 also function as memory elements within the array 320, storing actuation instructions for the illumination of an image frame.

The pixels 301 as well as the control matrix 300 of the array 320 are formed on a substrate 304. The array 320 includes an aperture layer 322, disposed on the substrate 304, which includes a set of apertures 324 for respective pixels 301 in the array 320. The apertures 324 are aligned with the shutter assemblies 302 in each pixel. In some implementations, the substrate 304 is made of a transparent material, such as glass or plastic. In some other implementations, the substrate 304 is made of an opaque material, but in which holes are etched to form the apertures 324.

The shutter assembly 302 together with the actuator 303 can be made bi-stable. That is, the shutters can exist in at least two equilibrium positions (for example, open or closed) with little or no power required to hold them in either position. More particularly, the shutter assembly 302 can be mechanically bi-stable. Once the shutter of the shutter assembly 302 is set in position, no electrical energy or holding voltage is required to maintain that position. The mechanical stresses on the physical elements of the shutter assembly 302 can hold the shutter in place.

The shutter assembly 302 together with the actuator 303 also can be made electrically bi-stable. In an electrically bi-stable shutter assembly, there exists a range of voltages below the actuation voltage of the shutter assembly, which if applied to a closed actuator (with the shutter being either open or closed), holds the actuator closed and the shutter in position, even if an opposing force is exerted on the shutter. The opposing force may be exerted by a spring such as the spring 207 in the shutter-based light modulator 200 depicted in FIG. 2, or the opposing force may be exerted by an opposing actuator, such as an “open” or “closed” actuator.

The light modulator array 320 is depicted as having a single MEMS light modulator per pixel. Other implementations are possible in which multiple MEMS light modulators are provided in each pixel, thereby providing the possibility of more than just binary “on” or “off” optical states in each pixel. Certain forms of coded area division gray scale are possible where multiple MEMS light modulators in the pixel are provided, and where apertures 324, which are associated with each of the light modulators, have unequal areas.

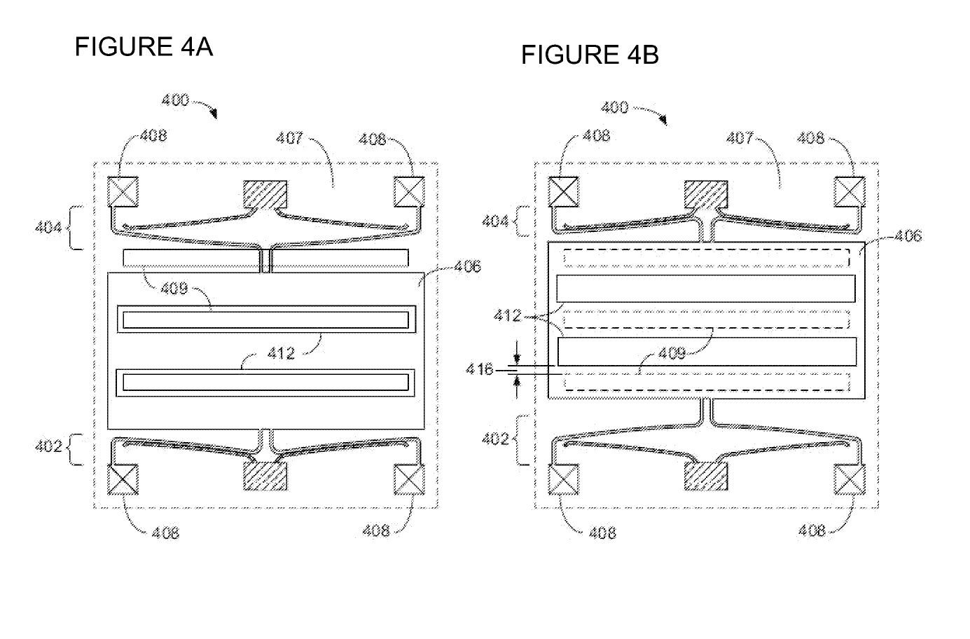

FIGS. 4A and 4B show views of an example dual actuator shutter assembly 400. The dual actuator shutter assembly 400, as depicted in FIG. 4A, is in an open state. FIG. 4B shows the dual actuator shutter assembly 400 in a closed state. In contrast to the shutter assembly 200, the shutter assembly 400 includes actuators 402 and 404 on either side of a shutter 406. Each actuator 402 and 404 is independently controlled. A first actuator, a shutter-open actuator 402, serves to open the shutter 406. A second opposing actuator, the shutter-close actuator 404, serves to close the shutter 406. Both of the actuators 402 and 404 are compliant beam electrode actuators. The actuators 402 and 404 open and close the shutter 406 by driving the shutter 406 substantially in a plane parallel to an aperture layer 407 over which the shutter is suspended. The shutter 406 is suspended a short distance over the aperture layer 407 by anchors 408 attached to the actuators 402 and 404. The inclusion of supports attached to both ends of the shutter 406 along its axis of movement reduces out of plane motion of the shutter 406 and confines the motion substantially to a plane parallel to the substrate. By analogy to the control matrix 300 of FIG. 3A, a control matrix suitable for use with the shutter assembly 400 might include one transistor and one capacitor for each of the opposing shutter-open and shutter-close actuators 402 and 404.

The shutter 406 includes two shutter apertures 412 through which light can pass. The aperture layer 407 includes a set of three apertures 409. In FIG. 4A, the shutter assembly 400 is in the open state and, as such, the shutter-open actuator 402 has been actuated, the shutter-close actuator 404 is in its relaxed position, and the centerlines of the shutter apertures 412 coincide with the centerlines of two of the aperture layer apertures 409. In FIG. 4B the shutter assembly 400 has been moved to the closed state and, as such, the shutter-open actuator 402 is in its relaxed position, the shutter-close actuator 404 has been actuated, and the light blocking drive electrodes of the shutter 406 are now in position to block transmission of light through the apertures 409 (depicted as dotted lines).

Each aperture has at least one edge around its periphery. For example, the rectangular apertures 409 have four edges. In alternative implementations in which circular, elliptical, oval, or other curved apertures are formed in the aperture layer 407, each aperture may have only a single edge. In some other implementations, the apertures need not be separated or disjoint in the mathematical sense, but instead can be connected. That is to say, while drive electrodes or shaped sections of the aperture may maintain a correspondence to each shutter, several of these sections may be connected such that a single continuous perimeter of the aperture is shared by multiple shutters.

In order to allow light with a variety of exit angles to pass through apertures 412 and 409 in the open state, it is advantageous to provide a width or size for shutter apertures 412 which is larger than a corresponding width or size of apertures 409 in the aperture layer 407. In order to effectively block light from escaping in the closed state, it is preferable that the light blocking drive electrodes of the shutter 406 overlap the apertures 409. FIG. 4B shows a overlap 416, which can be predefined, between the edge of light blocking drive electrodes in the shutter 406 and one edge of the aperture 409 formed in the aperture layer 407.

The electrostatic actuators 402 and 404 are designed so that their voltage-displacement behavior provides a bi-stable characteristic to the shutter assembly 400. For each of the shutter-open and shutter-close actuators there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

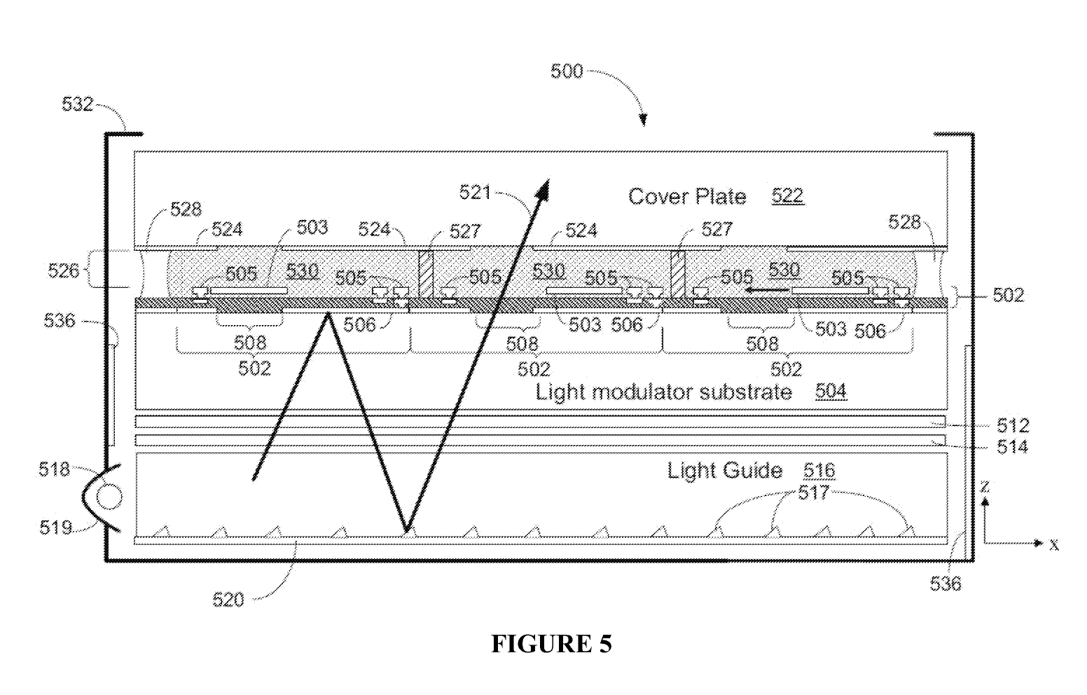

FIG. 5 shows a cross sectional view of an example display apparatus 500 incorporating shutter-based light modulators (shutter assemblies) 502. Each shutter assembly 502 incorporates a shutter 503 and an anchor 505. Not shown are the compliant beam actuators which, when connected between the anchors 505 and the shutters 503, help to suspend the shutters 503 a short distance above the surface. The shutter assemblies 502 are disposed on a transparent substrate 504, such a substrate made of plastic or glass. A rear-facing reflective layer or reflective film 506, disposed on the substrate 504 defines a plurality of surface apertures 508 located beneath the closed positions of the shutters 503 of the shutter assemblies 502. The reflective film 506 reflects light not passing through the surface apertures 508 back towards the rear of the display apparatus 500. The reflective film 506 can be a fine-grained metal film without inclusions formed in thin film fashion by a number of vapor deposition techniques including sputtering, evaporation, ion plating, laser ablation, or chemical vapor deposition (CVD). In some other implementations, the reflective film 506 can be formed from a mirror, such as a dielectric mirror. A dielectric mirror can be fabricated as a stack of dielectric thin films which alternate between materials of high and low refractive index. The vertical gap which separates the shutters 503 from the reflective film 506, within which the shutter is free to move, is in the range of 0.5 to 10 microns. The magnitude of the vertical gap is preferably less than the lateral overlap between the edge of shutters 503 and the edge of apertures 508 in the closed state, such as the overlap 416 depicted in FIG. 4B.

The display apparatus 500 includes an optional diffuser 512 and/or an optional brightness enhancing film 514 which separate the substrate 504 from a planar light guide 516. The light guide 516 includes a transparent, i.e., glass or plastic material. The light guide 516 is illuminated by one or more light sources 518, forming a backlight. The light sources 518 can be, for example, and without limitation, incandescent lamps, fluorescent lamps, lasers or light emitting diodes (LEDs). A reflector 519 helps direct light from lamp 518 towards the light guide 516. A front-facing reflective film 520 is disposed behind the backlight 516, reflecting light towards the shutter assemblies 502. Light rays such as ray 521 from the backlight that do not pass through one of the shutter assemblies 502 will be returned to the backlight and reflected again from the film 520. In this fashion light that fails to leave the display apparatus 500 to form an image on the first pass can be recycled and made available for transmission through other open apertures in the array of shutter assemblies 502. Such light recycling has been shown to increase the illumination efficiency of the display.

The light guide 516 includes a set of geometric light redirectors or prisms 517 which re-direct light from the lamps 518 towards the apertures 508 and hence toward the front of the display. The light redirectors 517 can be molded into the plastic body of light guide 516 with shapes that can be alternately triangular, trapezoidal, or curved in cross section. The density of the prisms 517 generally increases with distance from the lamp 518.

In some implementations, the reflective film 506 can be made of a light absorbing material, and in alternate implementations the surfaces of shutter 503 can be coated with either a light absorbing or a light reflecting material. In some other implementations, the reflective film 506 can be deposited directly on the surface of the light guide 516. In some implementations, the reflective film 506 need not be disposed on the same substrate as the shutters 503 and anchors 505 (such as in the MEMS-down configuration described below).

In some implementations, the light sources 518 can include lamps of different colors, for instance, the colors red, green and blue. A color image can be formed by sequentially illuminating images with lamps of different colors at a rate sufficient for the human brain to average the different colored images into a single multi-color image. The various color-specific images are formed using the array of shutter assemblies 502. In another implementation, the light source 518 includes lamps having more than three different colors. For example, the light source 518 may have red, green, blue and white lamps, or red, green, blue and yellow lamps. In some other implementations, the light source 518 may include cyan, magenta, yellow and white lamps, red, green, blue and white lamps. In some other implementations, additional lamps may be included in the light source 518. For example, if using five colors, the light source 518 may include red, green, blue, cyan and yellow lamps. In some other implementations, the light source 518 may include white, orange, blue, purple and green lamps or white, blue, yellow, red and cyan lamps. If using six colors, the light source 518 may include red, green, blue, cyan, magenta and yellow lamps or white, cyan, magenta, yellow, orange and green lamps.

A cover plate 522 forms the front of the display apparatus 500. The rear side of the cover plate 522 can be covered with a black matrix 524 to increase contrast. In alternate implementations the cover plate includes color filters, for instance distinct red, green, and blue filters corresponding to different ones of the shutter assemblies 502. The cover plate 522 is supported a distance away, which in some implementations may be predetermined, from the shutter assemblies 502 forming a gap 526. The gap 526 is maintained by mechanical supports or spacers 527 and/or by an adhesive seal 528 attaching the cover plate 522 to the substrate 504.

The adhesive seal 528 seals in a fluid 530. The fluid 530 is engineered with viscosities preferably below about 10 centipoise and with relative dielectric constant preferably above about 2.0, and dielectric breakdown strengths above about 10⁴ V/cm. The fluid 530 also can serve as a lubricant. In some implementations, the fluid 530 is a hydrophobic liquid with a high surface wetting capability. In alternate implementations, the fluid 530 has a refractive index that is either greater than or less than that of the substrate 504.

Displays that incorporate mechanical light modulators can include hundreds, thousands, or in some cases, millions of moving elements. In some devices, every movement of an element provides an opportunity for static friction to disable one or more of the elements. This movement is facilitated by immersing all the parts in a fluid (also referred to as fluid 530) and sealing the fluid (for example, with an adhesive) within a fluid space or gap in a MEMS display cell. The fluid 530 is usually one with a low coefficient of friction, low viscosity, and minimal degradation effects over the long term. When the MEMS-based display assembly includes a liquid for the fluid 530, the liquid at least partially surrounds some of the moving parts of the MEMS-based light modulator. In some implementations, in order to reduce the actuation voltages, the liquid has a viscosity below 70 centipoise. In some other implementations, the liquid has a viscosity below 10 centipoise. Liquids with viscosities below 70 centipoise can include materials with low molecular weights: below 4000 grams/mole, or in some cases below 400 grams/mole. Fluids 530 that also may be suitable for such implementations include, without limitation, de-ionized water, methanol, ethanol and other alcohols, paraffins, olefins, ethers, silicone oils, fluorinated silicone oils, or other natural or synthetic solvents or lubricants. Useful fluids can be polydimethylsiloxanes (PDMS), such as hexamethyldisiloxane and octamethyltrisiloxane, or alkyl methyl siloxanes such as hexylpentamethyldisiloxane. Useful fluids can be alkanes, such as octane or decane. Useful fluids can be nitroalkanes, such as nitromethane. Useful fluids can be aromatic compounds, such as toluene or diethylbenzene. Useful fluids can be ketones, such as butanone or methyl isobutyl ketone. Useful fluids can be chlorocarbons, such as chlorobenzene. Useful fluids can be chlorofluorocarbons, such as dichlorofluoroethane or chlorotrifluoroethylene. Other fluids considered for these display assemblies include butyl acetate and dimethylformamide. Still other useful fluids for these displays include hydro fluoro ethers, perfluoropolyethers, hydro fluoro poly ethers, pentanol, and butanol. Example suitable hydro fluoro ethers include ethyl nonafluorobutyl ether and 2-trifluoromethyl-3-ethoxydodecafluorohexane.

A sheet metal or molded plastic assembly bracket 532 holds the cover plate 522, the substrate 504, the backlight and the other component parts together around the edges. The assembly bracket 532 is fastened with screws or indent tabs to add rigidity to the combined display apparatus 500. In some implementations, the light source 518 is molded in place by an epoxy potting compound. Reflectors 536 help return light escaping from the edges of the light guide 516 back into the light guide 516. Not depicted in FIG. 5 are electrical interconnects which provide control signals as well as power to the shutter assemblies 502 and the lamps 518.

The display apparatus 500 is referred to as the MEMS-up configuration, where the MEMS based light modulators are formed on a front surface of the substrate 504, i.e., the surface that faces toward the viewer. The shutter assemblies 502 are built directly on top of the reflective film 506. In an alternate implementation, referred to as the MEMS-down configuration, the shutter assemblies are disposed on a substrate separate from the substrate on which the reflective aperture layer is formed. The substrate on which the reflective aperture layer is formed, defining a plurality of apertures, is referred to herein as the aperture plate. In the MEMS-down configuration, the substrate that carries the MEMS-based light modulators takes the place of the cover plate 522 in the display apparatus 500 and is oriented such that the MEMS-based light modulators are positioned on the rear surface of the top substrate, i.e., the surface that faces away from the viewer and toward the light guide 516. The MEMS-based light modulators are thereby positioned directly opposite to and across a gap from the reflective film 506. The gap can be maintained by a series of spacer posts connecting the aperture plate and the substrate on which the MEMS modulators are formed. In some implementations, the spacers are disposed within or between each pixel in the array. The gap or distance that separates the MEMS light modulators from their corresponding apertures is preferably less than 10 microns, or a distance that is less than the overlap between shutters and apertures, such as overlap 416.

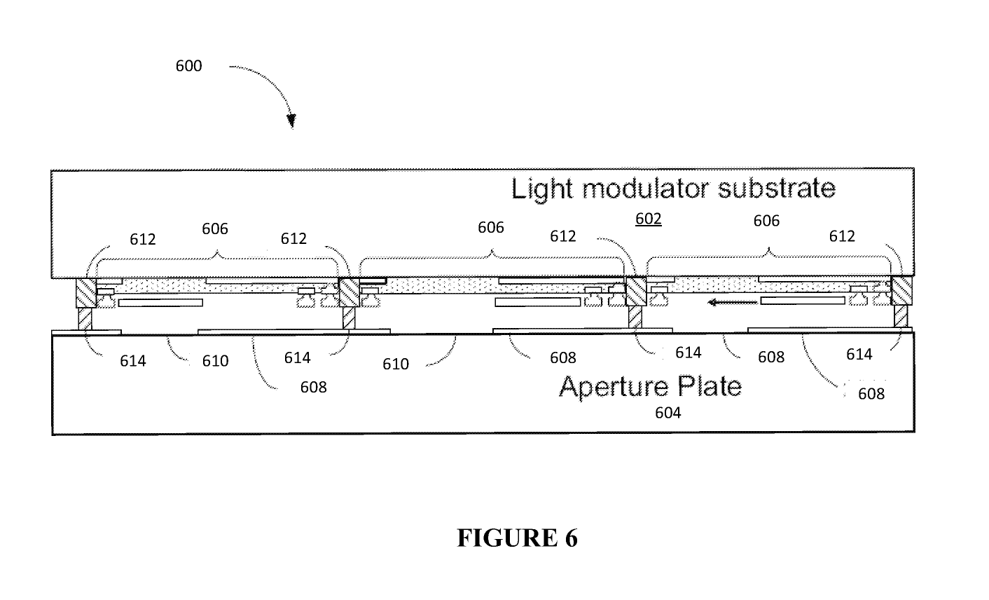

FIG. 6 shows a cross sectional view of an example light modulator substrate and an example aperture plate for use in a MEMS-down configuration of a display. The display assembly 600 includes a modulator substrate 602 and an aperture plate 604. The display assembly 600 also includes a set of shutter assemblies 606 and a reflective aperture layer 608. The reflective aperture layer 608 includes apertures 610. A gap or separation, which in some implementations may be predetermined, between the modulator substrates 602 and the aperture plate 604 is maintained by the opposing set of spacers 612 and 614. The spacers 612 are formed on or as part of the modulator substrate 602. The spacers 614 are formed on or as part of the aperture plate 604. During assembly, the two substrates 602 and 604 are aligned so that spacers 612 on the modulator substrate 602 make contact with their respective spacers 614.

The separation or distance of this illustrative example is 8 microns. To establish this separation, the spacers 612 are 2 microns tall and the spacers 614 are 6 microns tall. Alternately, both spacers 612 and 614 can be 4 microns tall, or the spacers 612 can be 6 microns tall while the spacers 614 are 2 microns tall. In fact, any combination of spacer heights can be employed as long as their total height establishes the desired separation H12.

Providing spacers on both of the substrates 602 and 604, which are then aligned or mated during assembly, has advantages with respect to materials and processing costs. The provision of a very tall, such as larger than 8 micron spacers, can be costly as it can require relatively long times for the cure, exposure, and development of a photo-imageable polymer. The use of mating spacers as in display assembly 600 allows for the use of thinner coatings of the polymer on each of the substrates.

In another implementation, the spacers 612 which are formed on the modulator substrate 602 can be formed from the same materials and patterning blocks that were used to form the shutter assemblies 606. For instance, the anchors employed for shutter assemblies 606 also can perform a function similar to spacer 612. In this implementation, a separate application of a polymer material to form a spacer would not be required and a separate exposure mask for the spacers would not be required.

Display apparatus including MEMS shutter-based light modulators can be used to achieve 3D image generation without requiring a viewer to wear glasses. To generate a 3D image, a display apparatus can be caused to form a left eye image and a right eye image that can be different from the left eye image. A right eye image is an image formed from light emitting from the display pixels having an angular distribution weighted more heavily towards the right side of the display, and thus towards the right eye of a viewer. Conversely, a left eye image is an image formed from light emitting from the display pixels having an angular distribution weighted more heavily towards the left side of the display, and thus towards the left eye of a viewer. As used herein, a right eye image or a left eye image may refer to a full image frame or an image subframe output as part of a time-division multiplexing display process.

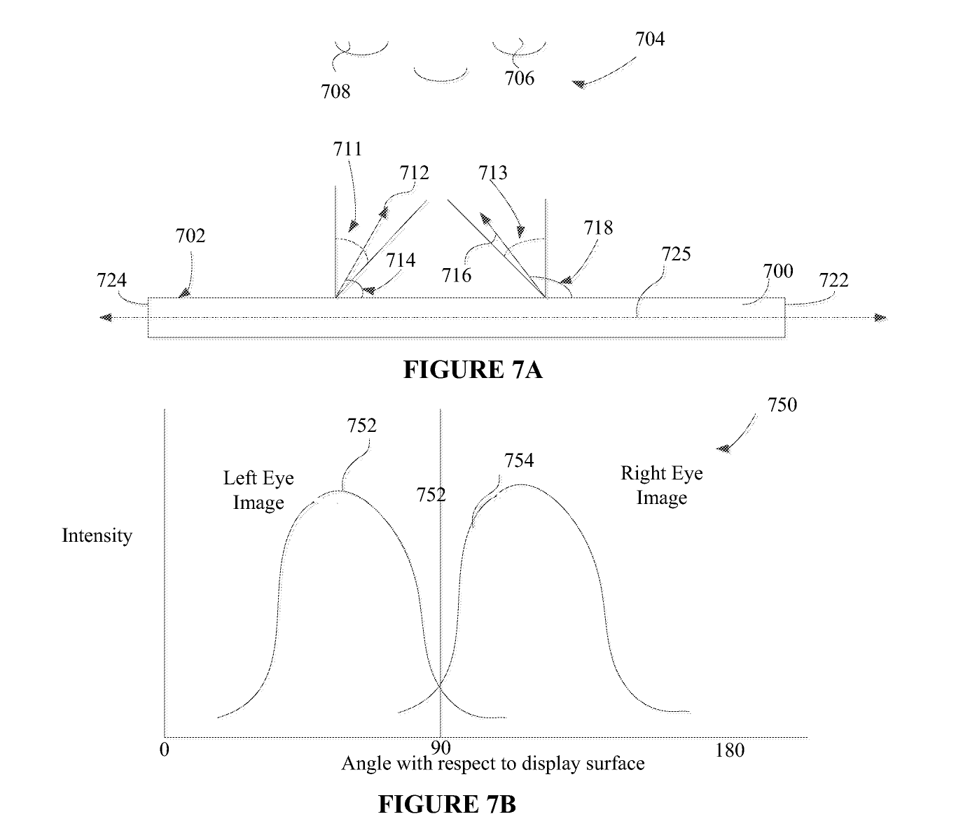

FIG. 7A shows an example plan view of a display apparatus 700 that generates left eye images and a right eye images for viewing by a viewer 704. The display apparatus 700 includes a display surface 702 that has a left side 722 and a right side 724. The display surface 702 includes apertures through which light is directed towards the viewer 704. Light directed towards the left side 722 of the display and thus the left eye 706 of the viewer 704 forms left eye images (“left eye image light 711”). Light directed towards the right side 724 of the display and thus the right eye 708 of the viewer 704 forms right eye images (“right eye image light 713”). Light exiting the display forms an angle 714 with respect to an axis 725 of the display surface 702 that extends from the left side 722 to the right side 724 of the display apparatus 700. Light that is directed perfectly towards the left side 722 parallel to the display surface 702 forms a zero angle with the axis 725. Light directed perfectly towards the right side 724 parallel to the display surface 702 forms a 180 degree angle with the axis 725. As depicted in FIG. 7A, by light ray 712 corresponding to the mean intensity angle of the left eye image light 711, the left eye image light 711 forms a mean angle 714 with respect to the axis 725 that is less than 90 degrees. As depicted by the light ray 716, which corresponds to the mean intensity angle of the right eye image light 713, the right eye image light 713 forms a mean angle 718 with respect to the same axis of the display surface 702 that is greater than 90 degrees.

FIG. 7B shows an example diagram 750 of two curves indicating angular distribution of light that form left and right eye images in the display apparatus 700 depicted in FIG. 7A. Referring to FIGS. 7A and 7B, a first curve 752 depicts an example angular distribution of the left eye image light 711. A second curve 754 depicts an example angular distribution of the right eye image light 713. Since light generally directed towards the left eye has an angle 714 of less than 90 degrees with respect to the axis 725 of the display surface 702, the angular distribution of the left eye image light 711 is weighted more heavily at angles less than 90 degrees as indicated by the curve 752. Conversely, since light generally directed towards the right eye has an angle 718 of greater than 90 degrees with respect to the axis 725 of the display surface 702, the angular distribution of right eye image light 713 is weighted more heavily at angles greater than 90 degrees, as indicated by the curve 754. The weighting does not have to be overly substantial to achieve its affect. In some implementations, a difference in peak intensity angles between the left eye image light 711 and the right eye image light 713 of about 1 degree is sufficient to induce some 3D perception in a viewer. In other words, a viewer can perceive an image as a 3D image if the peak intensity angle of a left eye image is offset from the peak intensity angle of a right eye image by about 1 degree. Accordingly, in some implementations, the display generates left eye images having an angular intensity distribution with a peak intensity angle that is offset from the peak intensity angle of the right eye image by about at least 1 degree. In some implementations, the offset between the peak intensity angles of left eye and right eye images is between about 1 degree and about 5 degrees. In some other implementations, the offset between the peak intensity angles of left eye and right eye images generated by the display is greater than about 5 degrees. In some other implementations, the display generates left eye images that have an angular intensity distribution with a peak intensity at least 1 degree away from the display normal in a first direction and generates left eye images that have an angular intensity distribution with a peak intensity at least 1 degree away from the display normal in a second, opposite direction. In some implementations, the angle of peak intensity of the right eye and left eye images are between about 1 and about 5 degrees away from the display normal in opposite directions. In some other implementations, the peak intensity angles of the left eye images and right eye-images are greater than about 5 degrees away from the display normal.

A display can output left eye images and right eye images by incorporating an array of parallax barrier shutters into a display. In some implementations, the display includes a rear substrate on which a light blocking layer is formed. A plurality of rear apertures are formed through the light blocking layer. The display also includes a plurality of display elements, for example, shutter assemblies, each of which corresponds to an underlying rear aperture. Each of the display elements is configured to modulate light passing through the rear apertures from a backlight. In some implementations, any given display element can be driven to a light blocking state in which the display element blocks light passing through the underlying rear aperture or a light transmissive state in which the display element allows the light passing through the underlying rear aperture to pass through the display element.

The array of parallax barrier shutters referred to above is formed on a rear facing surface of a transparent front substrate. In some implementations, each of the parallax barrier shutters corresponds to a respective display element and is configured to be driven to a left eye image state or a right eye image state relative to an underlying rear aperture. When a particular parallax barrier shutter is driven to the left eye image state, the parallax barrier shutter blocks some light from a corresponding display element. The remaining light, which is unblocked and passes by or through the parallax barrier shutter, has an angular distribution weighted towards the left eye of a viewer to form a left eye image. When the particular parallax barrier shutter is driven to the right eye image state, the parallax barrier shutter also blocks some light from the corresponding display element. However, in this case, the remaining unblocked light has an angular distribution weighted towards the right eye of the viewer to form a right eye image. In this way, depending on the position of the parallax barrier shutter, light passing through the underlying display element forms either a left eye image or a right eye image.

In some other implementations, each parallax barrier shutter may be sized to correspond to two or more display elements. In such implementations, each parallax barrier shutter may concurrently impact the angular distribution of light output by each of its corresponding display elements.

In some implementations, the parallax barrier shutters that form the array of parallax barrier shutters are electrically connected and are controlled by a common control signal (e,g, a voltage), for example, by being coupled to a common voltage interconnect, to a common voltage source, or multiple voltage sources that are configured to output substantially the same voltages. As a result, all of the shutters can be readily driven to the same state at the same time. In such implementations, a display controller, at a given time, outputs display element data corresponding to a left eye image to all display elements in the display. At a subsequent time, the display controller outputs display element data corresponding to a right eye image to all display elements in the display, alternating between the two.

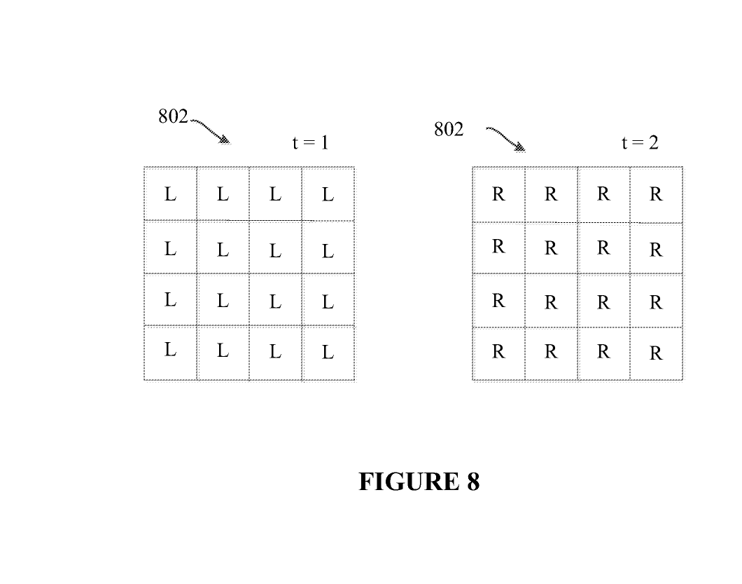

FIG. 8 shows an example portion of a display 802 at two points in time. The display 802 operates according to a temporal multiplexing process to form 3D images. The display 802 includes an array of display elements. Each display element has a corresponding parallax barrier shutter. The grid shown in FIG. 8 represents an array of these parallax barrier shutters. Each parallax barrier shutter in FIG. 8 is labeled with an L or R. The label indicates whether the parallax barrier shutter is in a state in which the light passing by or through the parallax barrier shutter contributes to a left eye image (L) or a right eye image (R). As shown, at a time t=1, all parallax barrier shutters in the portion of the display 802 are in a state such that light passing by or through the parallax barrier shutter contributes to a left eye image. At time t=2, the same parallax barrier shutters in the portion of the display 802 are in a state such that light passing by or through the parallax barrier shutter contributes to a right eye image. In some implementations, the parallax barrier shutters can be assigned to alternate between a left eye image state and a right eye image state. In this way, a display controller can temporally multiplex left and right eye images on the display 802 using the same parallax barrier shutters of the display 802. In some implementations, the parallax barrier shutters may transition between a left eye image state and a right eye image state according to a subframe sequence. The subframe sequence may be arranged such that left eye images and right eye images are displayed in an alternating manner.

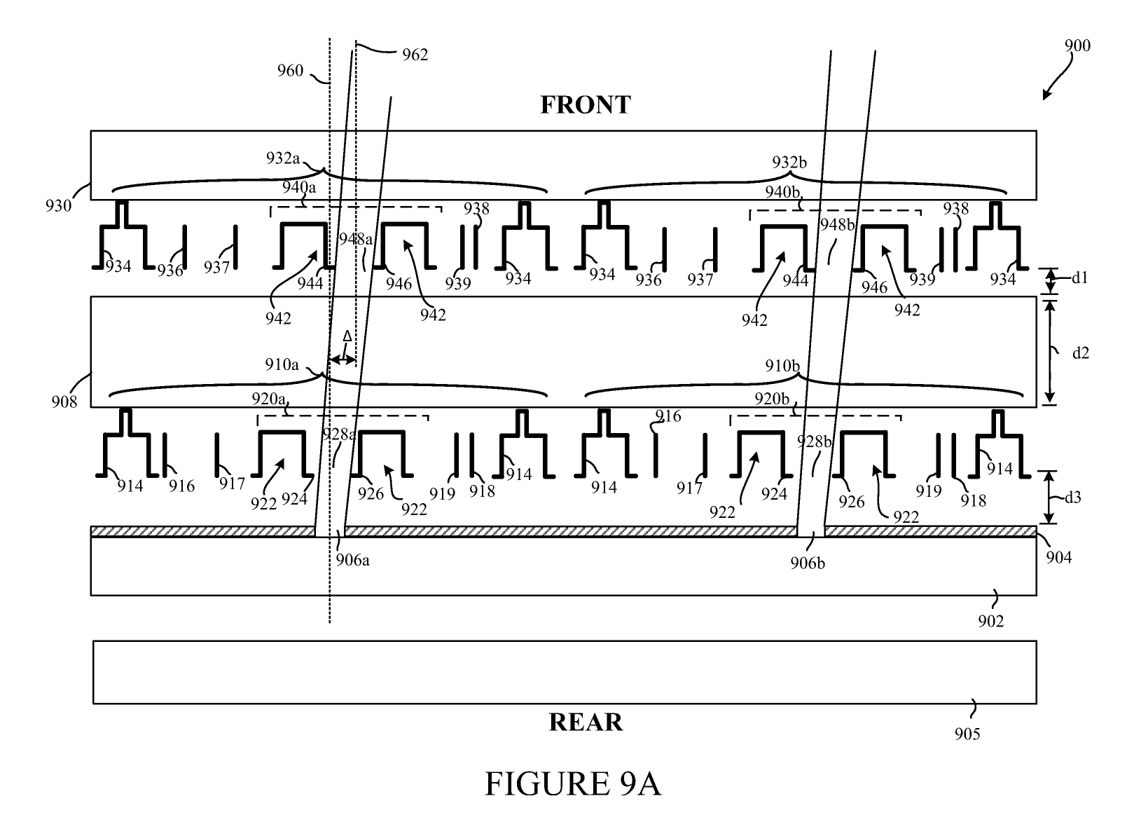

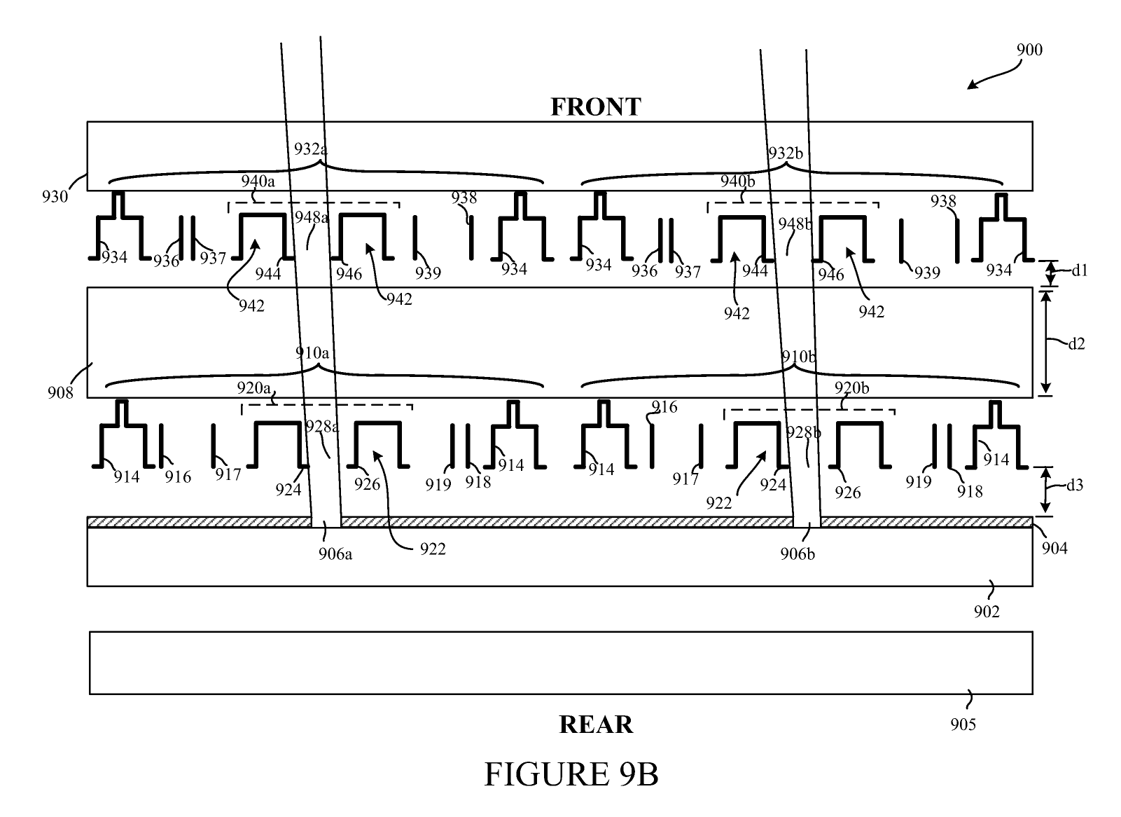

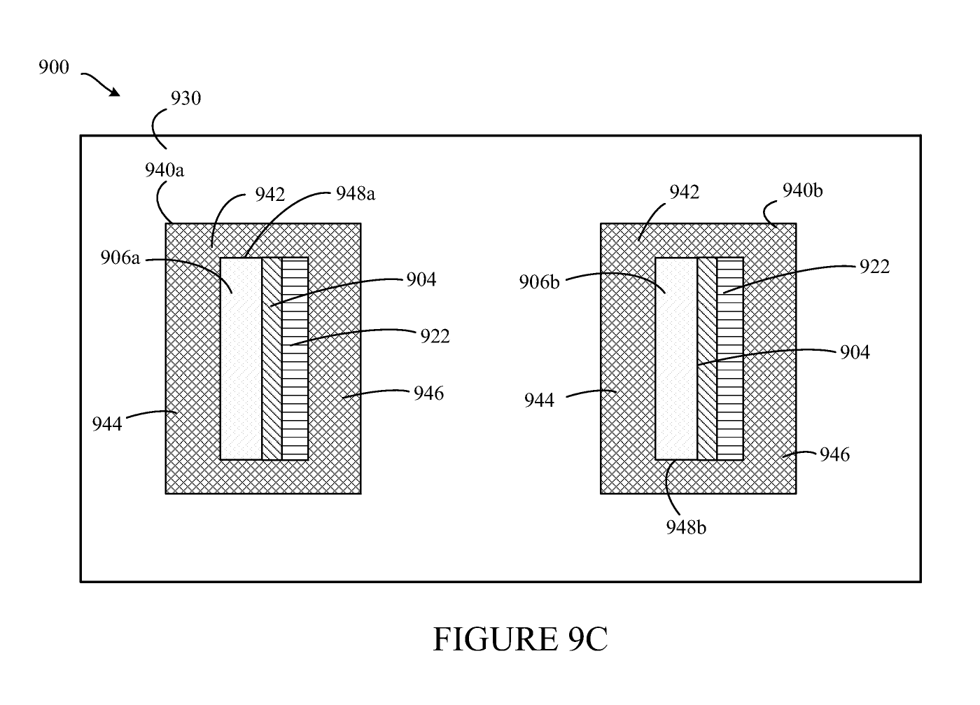

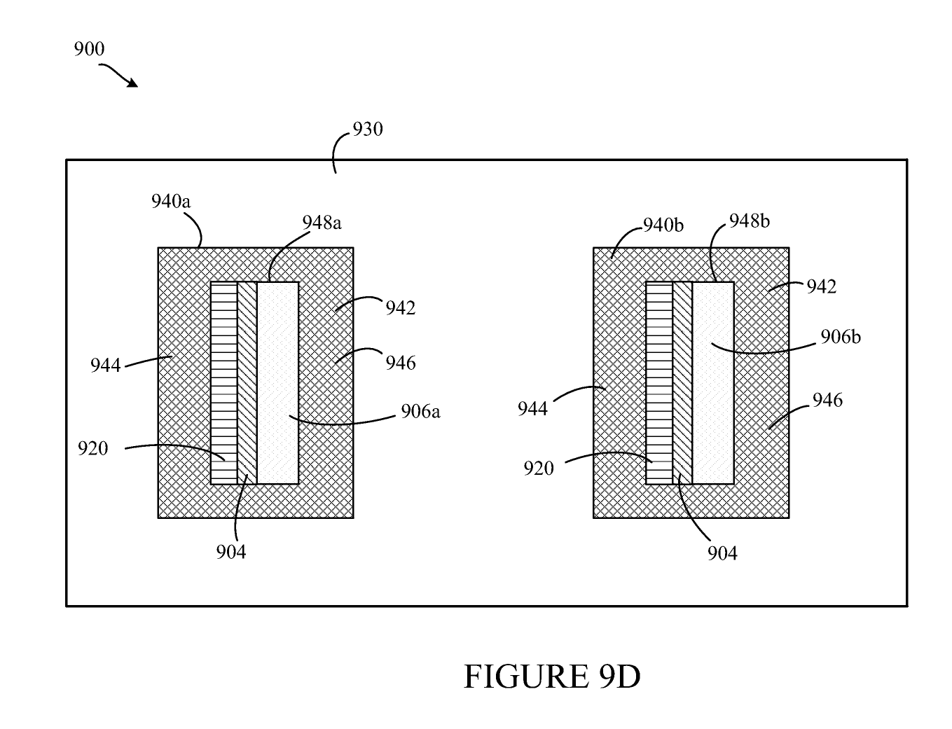

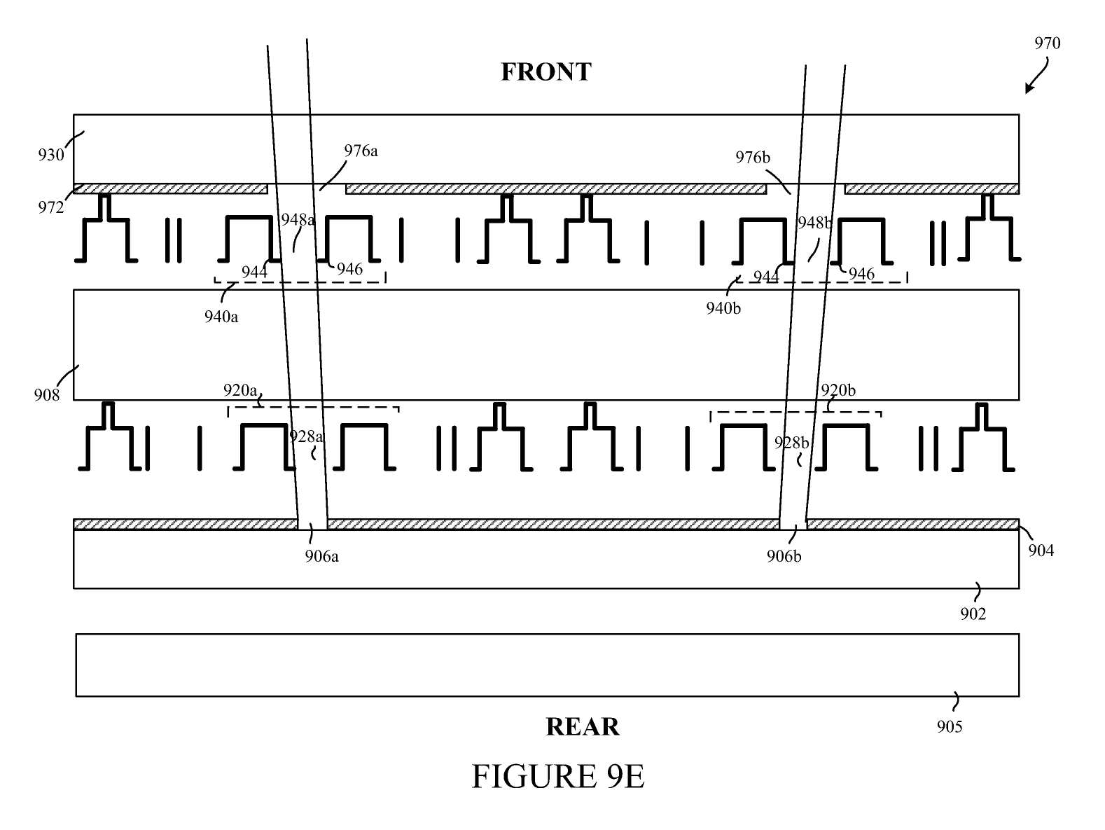

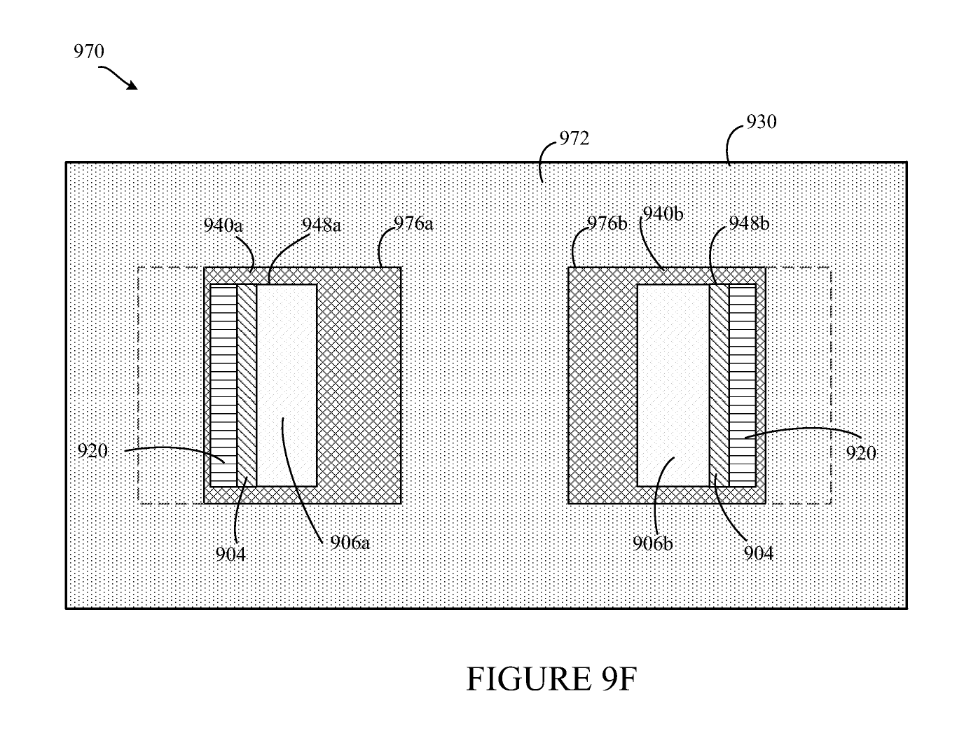

FIG. 9A shows a cross-sectional view of an example display 900. The display 900 is configured to form left eye images and right eye images. In particular, the display 900 includes an array of parallax barrier shutter assemblies 932a and 932b positioned in front of an array of EMS shutter-based display elements 910a and 910b. At any given time, the parallax barrier shutter assemblies 932a and 932b can be driven to one of a right eye image state or a left eye image state. As shown in FIG. 9A, the parallax barrier shutter assemblies 932a and 932b are in the right eye image state. When the parallax barrier shutter assemblies 932a and 932b are driven to the right eye image state, light output from the display 900 forms a right eye image, which as described above, has an angular distribution weighted more heavily towards the right eye of a viewer. Conversely, when the parallax barrier shutter assemblies 932a and 932b are driven to the left eye image state, light output from the display 900 forms a left eye image, which as described above, has an angular distribution weighted more heavily towards the left eye of a viewer. FIG. 9B shows the display 900 in which the parallax barrier shutter assemblies 932a and 932b are driven to the left-eye image state.

Referring to FIGS. 9A and 9B, the display 900 includes a rear substrate 902 having a light reflecting layer 904 through which a plurality of rear apertures, including a first rear aperture 906a and a second rear aperture 906b (generally a rear aperture 906) are formed. This rear substrate 902 also is referred to as an aperture plate 902.

The display 900 includes a backlight 905 positioned at the rear of the display 900 such that light from the backlight 905 can pass through the rear apertures 906a and 906b towards the front of the display 900 to form left eye images and right eye images.

A transparent modulator substrate 908 is positioned in front of the rear substrate 902. A plurality of display elements including a first display element 910a and a second display element 910b (generally display elements 910) are formed on a rear facing surface of the modulator substrate 908. The first display element 910a corresponds to the first rear aperture 906a and the second display element 910b corresponds to the second rear aperture 906b.

The first display element 910a, in some implementations, is a shutter assembly. In some such implementations, the first display element 910a includes anchors 914, a first drive electrode 916 and a first load electrode 918 that form a first actuator, a second drive electrode 917 and a second load electrode 919 that form a second actuator, and a display shutter 920a that is configured to be driven by the first and second actuators. In some implementations, a display shutter aperture 928a is formed through a light blocking portion 922 of the first display shutter 920a. The light blocking portion 922 includes a left light blocking portion 924 that defines a left side of the first display shutter aperture 928a and a right light blocking portion 926 that defines a right side of the first display shutter aperture 928a.

The second display element 910b includes a shutter assembly that is identical to the first display element 910a. The shutter assembly of the second display element 910b includes anchors 914, a first drive electrode 916 and a first load electrode 918 that form a first actuator, a second drive electrode 917 and a second load electrode 919 that form a second actuator, and a second display shutter 920b that is configured to be driven by the first and second actuators. In some implementations, a display shutter aperture 928b is formed through a light blocking portion 922 of the second display shutter 920b. The light blocking portion 922 includes a left light blocking portion 924 that defines a left side of the second display shutter aperture 928b and a right light blocking portion 926 that defines a right side of the second display shutter aperture 928b.

The first display shutter 920a and the second display shutter 920b (generally display shutters 920) can be driven between a light blocking state and a light transmissive state. The first display shutter 920a and the second display shutter 920b are configured to travel in a plane parallel to the plane of the rear substrate 902. When a display shutter 920 is in the light blocking state, the light blocking portion 922 of the display shutter 920 overlaps a respective underlying rear aperture 906a or 906b such that light passing through the rear aperture 906 that is directed towards the front of the display is blocked by the light blocking portion 922 of the display shutter 920. Conversely, when the display shutter 920 is in the light transmissive state, the center of the shutter aperture 928 is substantially aligned with the center of the underlying rear aperture 906a or 906b such that the light blocking portion 922 does not substantially overlap the underlying aperture 906. As a result, light passing through the rear aperture 906 passes through the display shutter aperture 928 towards the front of the display. As shown in FIG. 9A, the first display shutter 920a and the second display shutter 920b are in the light transmissive state.

A front substrate 930 is disposed over the modulator substrate 908. A first parallax barrier shutter assembly 932a and a second parallax barrier shutter assembly 932b (parallax barrier shutter assembly 932), similar to the shutter assemblies of the first and second display elements 910a and 910b, are formed on a rear surface of the front substrate 930 facing the rear substrate 902.

The first parallax barrier shutter assembly 932a corresponds to the first display element 910a and the first rear aperture 906a. The first parallax barrier shutter assembly 932a includes anchors 934, a first drive electrode 936 and a first load electrode 938 that form a first actuator, a second drive electrode 937 and a second load electrode 939 that form a second actuator, and a first parallax barrier shutter 940a that is configured to be driven by the first and second actuators. In some implementations, a first parallax barrier shutter aperture 948a is formed through a light blocking portion 942 of the first parallax barrier shutter 940a. The light blocking portion 942 includes a left light blocking portion 944 that defines a left side of the first parallax barrier shutter aperture 948a and a right light blocking portion 946 that defines a right side of the first parallax barrier shutter aperture 948a.

The second parallax barrier shutter assembly 932b corresponds to the second display element 910b and the second rear aperture 906b. The second parallax barrier shutter assembly 932b includes anchors 934, a first drive electrode 936 and a first load electrode 938 that form a first actuator, a second drive electrode 937 and a second load electrode 939 that form a second actuator, and a second parallax barrier shutter 940b that is configured to be driven by the first and second actuators. In some implementations, a second parallax barrier shutter aperture 948b is formed through a light blocking portion 942 of the second parallax barrier shutter 940b. The light blocking portion 942 includes a left light blocking portion 944 that defines a left side of the second parallax barrier shutter aperture 948b and a right light blocking portion 946 that defines a right side of the second parallax barrier shutter aperture 928b.

In the display 900 shown in FIGS. 9A and 9B, each of the first parallax barrier shutter assembly 932a and the second parallax barrier shutter assembly 932b operate in an identical manner. For ease of discussion, the operation of the first parallax barrier shutter assembly 932a is described below. The first parallax barrier shutter assembly 932a is configured to drive the first parallax barrier shutter 940a between a left eye image state and a right eye image state. The first parallax barrier shutter 940a is configured to travel substantially in a plane parallel to the plane of travel of the first display shutter 920a and the second display shutter 920b. When the first parallax barrier shutter 940a is in the right eye image state, the left light blocking portion 944 of the first parallax barrier shutter 940a partially overlaps a respective first side of the underlying first rear aperture 906a. As a result, assuming the first display shutter 920a is in the light transmissive state, some of the light that passes through the first rear aperture 906a and the display shutter aperture 928 of the first display shutter 920a is blocked by the left light blocking portion 944 of the first parallax barrier shutter 940a. The remaining light that passes through the first rear aperture 906a and the first display shutter aperture 928a of the first display shutter 920a passes through the first parallax barrier shutter aperture 948a. This remaining light has an angular distribution weighted more heavily towards the right eye of a viewer, thereby forming a right eye image. As such, the light can be viewed by the right eye of the viewer with greater intensity than by the left eye of the viewer. Conversely, when the parallax barrier shutter 940 is in the left eye image state, the right light blocking portion 946 of the parallax barrier shutter 940 partially overlaps a respective second side of the underlying first rear aperture 906a. Additional details regarding the left eye image state is described below with respect to FIG. 9B.

FIG. 9B shows an example cross-sectional view of the display 900 shown in FIG. 9A. The display 900 shown in FIG. 9B is configured such that the first and second parallax barrier shutters 940a and 940b are in the left eye image state. In this configuration, the display 900 can form left eye images. When the first and second parallax barrier shutters 940a and 940b are in the left eye image state, the right light blocking portion 946 of the first and second parallax barrier shutters 940a and 940b partially overlaps a respective second side of the underlying rear apertures 906a and 906b. As a result, assuming the first display shutter 920a is in the light transmissive state, some of the light that passes through the first rear aperture 906a and the first display shutter aperture 928a of the first display shutter 920a is blocked by the right light blocking portion 946 of the first parallax barrier shutter 940a. The remaining light that passes through the first rear aperture 906a and the first display shutter aperture 928a of the first display shutter 920a passes through the first parallax barrier shutter aperture 948a. This remaining light has an angular distribution weighted more heavily towards the left eye of the viewer, thereby forming a left eye image. As such, the light can be viewed by the left eye of the viewer with greater intensity than by the right eye of the viewer.

Still referring to FIGS. 9A and 9B, the display shutters 920 and the parallax barrier shutters 940 have front surfaces facing the front substrate 930 and rear surfaces facing the rear substrate 902. In some implementations, the front surfaces of the first and second display shutters 920a and 920b and the first and second parallax barrier shutters 940a and 940b may be coated with a light absorbing material to absorb ambient light incident on the shutters. The rear surfaces of the first and second display shutters 920a and 920b and the first and second parallax barrier shutters 940a and 940b may be coated with a light reflecting material, such as high reflectance metals, e.g., Al, Ag, or high reflectance metal with additional multi-layer dielectric coatings to reflect light from the backlight 905 for increasing light efficiency. Examples of light absorbing materials include but are not limited to metal and metal alloys, semiconductors and metal oxides or nitrides. In particular, examples of metal alloys which are effective at absorbing light, include, without limitation, MoCr, MoW, MoTi, MoTa, TiW, and TiCr. Metal films formed from the above alloys or simple metals, such as nickel (Ni) and chromium (Cr) with rough surfaces can also be effective at absorbing light. Semiconductor materials, such as amorphous or polycrystalline silicon (Si), germanium (Ge), cadmium telluride (CdTe), colloidal graphite (carbon) and alloys such as SiGe are also effective at absorbing light. Metal oxides or nitrides can also be effective at absorbing light, including without limitation copper oxide (CuO), chromium oxide (Cr₂0₃), silver oxide (AgO), tin oxide (SnO), zinc oxide (ZnO), amongst others.

Although not shown in FIGS. 9A and 9B, the display 900 also includes a controller, for example, the controller 134 shown in FIG. 1B. The controller is configured to cause the first and second parallax barrier shutters 940a and 940b to be driven into the left eye image state and the right eye image state. In some implementations, the controller can drive the first parallax barrier shutter 940a and the second parallax barrier shutter 940b into the left eye image state by causing a first voltage to be applied to the respective first actuators coupled to the first and second parallax barrier shutters 940a and 940b. Conversely, the controller can drive the first parallax barrier shutter 940a and the second parallax barrier shutter 940b to the right eye image state by causing a second voltage to be applied to the respective second actuators coupled to the first and second parallax barrier shutters 940a and 940b.

In some implementations, the controller can drive the first and second parallax barrier shutters 940a and 940b into the left eye image state in conjunction with providing image data corresponding to the left eye image to the corresponding first and second display element 910a and 910b. In this way, as the display elements 910a and 910b assume a state corresponding to the left eye image data, the corresponding parallax barrier shutters 940a and 940b can be driven into the appropriate state such that the light passing through parallax barrier shutter apertures 948a and 948b has an angular distribution weighted towards the left eye of the viewer. Conversely, if the display elements 910a and 910b are provided with image data to produce a right eye image, the controller can drive the corresponding parallax barrier shutters 940a and 940b to move to the right eye image state such that light from the display elements 910a and 910b that passes either of the parallax barrier shutter apertures 948a and 948b has an angular distribution weighted towards the right eye, causing the right eye image to be formed.

The distance a parallax barrier shutter, for example the first parallax barrier shutter 940a travels when moved from the left eye state to the right eye state depends on a number of factors. The factors include the size of the light blocking portion 942a of the parallax barrier shutter 940a, the size of the parallax barrier shutter aperture 948a and the size of the underlying rear aperture 906a. Generally, the size of the parallax barrier shutter aperture 948a is configured to be about the same size or slightly larger than the size of the rear aperture 906a. Having a parallax barrier shutter aperture 948a that is smaller than the size of the rear aperture 906a will result in unnecessary light being blocked by the light blocking portion 942 of the parallax barrier shutter 940a. Conversely, having a parallax barrier shutter aperture 948a that is much larger than the size of the rear aperture 906a can result in light leakage from within the display 900. In addition, in some implementations, the front surface of the parallax barrier shutter 940a can serve to absorb ambient light. In such implementations, having a parallax barrier shutter aperture 948a that is much larger than the size of the rear aperture 906a reduces the amount of ambient light absorbed by the parallax barrier shutter 940a, thereby adversely affecting the contrast ratio of the display 900.

In some implementations, the parallax barrier shutter 940a and the parallax barrier shutter aperture 948a and the display shutter aperture 928a may have about the same width. In some such implementations, the distance the parallax barrier shutter 940a travels between the left eye image state and the right eye image state is shorter than the distance the display shutter 920a travels between the light blocking state and the light transmission state. In some other implementations, the distance the parallax barrier shutter 940a travels between the left eye image state and the right eye image state can be the same as the distance the display shutter 920a travels between the light blocking state and the light transmission state.

When in a left eye image state or a right eye image state, the parallax barrier shutter 940a may be offset relative to the underlying display shutter 920a. In particular, the center of the parallax barrier shutter aperture 948a may be offset from the center of the display shutter aperture 928a and the underlying rear aperture 906a by a predetermined offset distance Δ. In FIG. 9A, the predetermined offset distance Δ is shown as the distance between a first line 960 that passes through the center of the first rear aperture 906a and a second line 962 that passes through the center of the first parallax barrier shutter aperture 948a. The predetermined offset distance Δ is based in part on the distance d₁ between the rear apertures 906 and a bottom surface of the light blocking portion 922 of the display shutter 920, the thickness d₂ of the modulator substrate 908 and the distance d₃ between the modulator substrate 908 and a bottom surface of the parallax barrier shutter 940. The predetermined offset distance Δ is also based on the viewing angle θ from either the left eye or the right eye of a viewer with respect to a display normal extending perpendicular to the planar surface of the front substrate 930 facing the viewer. The viewing angle θ may vary based on the distance between the viewer and the display. In particular, the predetermined offset distance Δ can be determined by solving the following two simultaneous equations for Δ:

Δ=(d₁+d₃)·tan θ+d₂·tan θ′ (i)

Δθ′=sin⁻¹[(sin θ)/n] (ii)

In one example implementation, the distance d₁ between the rear apertures 906 and a bottom surface of the light blocking portion 922 of the display shutter 920 and the distance d₃ between the modulator substrate 908 and a bottom surface of the parallax barrier shutter 940 is about 10 microns. The thickness d₂ of the modulator substrate 908 is about 0.5 mm and the refractive index of the modulator substrate n is about 1.5. For the viewing angle θ that is about 4 degrees, which is suitable for a hand-held display that is about 24 inches away from the viewer's eyes, the predetermined offset distance Δ is about 27 microns, which is small enough to accommodate in each of the display pixels of the display 900. In some other implementations, the above dimensions are different, and the resulting offset is between about 10 microns and about 40 microns.

As shown in FIG. 9A, the center of a parallax barrier shutter aperture is offset from the center of the corresponding aperture layer aperture towards a first side of the aperture layer aperture by the predetermined offset distance Δ. In this configuration, the light passing through the apertures forms a right eye image. Conversely, to form a left eye image, the center of the parallax barrier shutter aperture is offset from the center of the corresponding aperture layer aperture towards a second side of the aperture layer aperture opposite the first side by the same predetermined offset distance Δ. As such, the distance the parallax barrier shutter has to travel between the right eye image state and the left eye image state is two times the predetermined offset distance Δ (2Δ).

In some implementations, the display shutter assemblies 910a and 910b and the parallax barrier shutter assemblies 932a and 932b are EMS shutter assemblies. For example, the display shutter assemblies 910a and 910b and the parallax barrier shutter assemblies 932a and 932b both may be microelectromechanical system MEMS-based shutter assemblies. In some such implementations, the first and second display shutters 920a and 920b have a electromechanical structure that is substantially identical to the electromechanical structure of the parallax barrier shutters 940a and 940b.

In some implementations, the first and second parallax barrier shutter assemblies 932a and 932b may have a different design or architecture from the first and second display elements 910a and 910b. In some implementations, the display elements 910a and 910b may not be shutter-based display elements. For example, the display elements 910a and 910b may be OLEDs, or any other light modulators that can selectively transmit light.

FIG. 9C shows an example top view of a portion of the display 900. The portion of the display 900 shown in FIG. 9C corresponds to the portion of the display 900 as shown in FIG. 9A. It should be noted that the top view corresponds to a view normal to the front substrate 930 of the display 900. As described above with respect to FIG. 9A, the first and second parallax barrier shutters 940a and 940b of both the first parallax barrier shutter assembly 932a and the second parallax barrier shutter assembly 932b are in the right eye image state such that the light passing through the parallax barrier shutter apertures 948a and 948b of the first parallax barrier shutter assembly 932a and the second parallax barrier shutter assembly 932b respectively, has an angular distribution weighted more heavily towards the right eye.

In FIG. 9C, the front surface of the front substrate 930 when viewed from a position normal to the display 900 is shown. Since the front substrate 930 is transparent, the first parallax barrier shutter 940a and the second parallax barrier shutter 940b formed on the rear surface of the front substrate 930 can be seen. The first parallax barrier shutter 940a includes the light blocking portion 942 having the left light blocking portion 944 and the right light blocking portion 946 that together define the parallax barrier shutter aperture 948a.

As shown in FIG. 9A, the center of the first display shutter aperture 928a of the display shutter 920a is substantially aligned with the center of the rear aperture 906a. Further, the parallax barrier shutter 940a is offset relative to the center of the display shutter aperture 928a and the center of the rear aperture 906a. In particular, the parallax barrier shutter 940a is offset towards the right side of the rear aperture 906a such that the left light blocking portion 944 blocks the left side of the underlying rear aperture 906a, while the right light blocking portion 946 overlaps a light blocking portion 922 of the underlying display shutter 920.

As such, when the first parallax barrier shutter aperture 948a is viewed normal to the front substrate 930 as shown in FIG. 9C, a front-facing surface of a portion of the light blocking portion 922 of the display shutter 920 is visible. Assuming that the display shutter aperture 928a is slightly larger than the underlying rear aperture 906a, a portion of the light blocking layer 904 that defines the right side of the rear aperture 906a is also visible. In this way, when the parallax barrier shutter 940a is in the right eye image state and the display shutter 920 is in a light transmissive state, a portion of the display shutter 920, a portion of the underlying light blocking layer 904 of the rear substrate 902 and a portion of the first rear aperture 906a are visible. The ratio of the widths of the portions of the first display shutter 920a, the light blocking layer 904 and the rear aperture 906a that are visible through the first parallax barrier shutter aperture 948a depends on the size of the parallax barrier shutter aperture 948, the amount of overlap between the left light blocking portion 944 of the first parallax barrier shutter 940a and the first rear aperture 906a, the width of the first display shutter aperture 928a and the width of the first rear aperture 906a.

Since the first parallax barrier shutter 940a and the second parallax barrier shutter 940b are both in the first eye image state and both the underlying first and second display shutters 920a and 920b are in the light transmissive state, a similar view can be seen through the second parallax barrier shutter aperture 948b. In particular, when the second parallax barrier shutter aperture 948b is in the right eye image state and the second display shutter 920b is in a light transmissive state, a front surface of a light blocking portion 922 of the second display shutter 928b, a portion of the underlying light blocking layer 904 of the rear substrate 902 and a portion of the second rear aperture 906b are visible.

FIG. 9D shows another example top view of a portion of the display 900. The portion of the display 900 shown in FIG. 9D corresponds to the portion of the display 900 as shown in FIG. 9B. It should be noted that the top view corresponds to a view normal to the front substrate 930 of the display 900. As described above with respect to FIG. 9B, the parallax barrier shutters 940 of both the first parallax barrier shutter assembly 932a and the second parallax barrier shutter assembly 932b are in the left eye image state such that the light passing through the first and second parallax barrier shutter apertures 948a and 948b has an angular distribution weighted more heavily towards the left eye.

As shown in FIG. 9D, the front surface of the front substrate 930 when viewed from a position normal to the display 900 is shown. Since the front substrate 930 is transparent, the first parallax barrier shutter 940a and the second 940b formed on the rear surface of the front substrate 930 can be seen. The first parallax barrier shutter 940a includes the light blocking portion 942 having the left light blocking portion 944 and the right light blocking portion 946 that together define the parallax barrier shutter aperture 948a.

As shown in FIG. 9B, the center of the display shutter aperture 928a of the display shutter 920a is aligned with the center of the rear aperture 906a. Further, the first parallax barrier shutter 940a is offset relative to the center of the first display shutter aperture 928a and the center of the first rear aperture 906a. In particular, the first parallax barrier shutter 940a is offset towards the left side of the rear aperture 906a such that the right light blocking portion 946 blocks the right side of the underlying rear aperture 906a, while the left light blocking portion 944 overlaps a light blocking portion of the underlying first display shutter 920a.

As such, when the first parallax barrier shutter aperture 948a is viewed normal to the front substrate 930 as shown in FIG. 9D, a front facing surface of a portion of the light blocking portion 922 of the display shutter 920a is visible. Assuming that the display shutter aperture 928a is slightly larger than the underlying rear aperture 906a, a portion of the light blocking layer 904 that defines the right side of the rear aperture 906a is also visible. In this way, when the first parallax barrier shutter 940a is in the left eye image state and the first display shutter 920a is in a light transmissive state, a portion of the first display shutter 920a, a portion of the underlying light blocking layer 904 of the rear substrate 902 and a portion of the first rear aperture 906a are visible. The ratio of the widths of the portions of the first display shutter 920a, the light blocking layer 904 and the first rear aperture 906a that are visible through the first parallax barrier shutter aperture 948a depends on the size of the first parallax barrier shutter aperture 948a, the amount of overlap between the left light blocking portion 944 of the first parallax barrier shutter 940a and the rear aperture 906a, the width of the first display shutter aperture 928a and the width of the first rear aperture 906a.

Since the first parallax barrier shutter 940a and the second parallax barrier shutter 940b shown in FIG. 9B are both in the left eye image state and both the underlying first and second display shutters 920a and 920b are in the light transmissive state, a similar view can be seen through the second parallax barrier shutter aperture 948b. In particular, when the second parallax barrier shutter aperture 948b is in the right eye image state and the second display shutter 920b is in a light transmissive state, a front-facing surface of the light blocking portion 922 of the second display shutter 928b, the underlying light blocking layer 904 of the rear substrate 902 and a portion of the rear aperture 906b are visible.

FIG. 9E shows an example cross-sectional view of a display 970. The display 970 is substantially similar to the display 900 shown in FIG. 9A. The display 970 is capable of displaying portions of both a left eye image and a right eye image at the same time. As shown in FIG. 9E, the first parallax barrier shutter 940a can be positioned to allow light passing through the parallax barrier shutter aperture 948a to form a right eye image, while the second parallax barrier shutter 940b can be positioned to allow light passing through the parallax barrier shutter aperture 948b to form a left eye image.

The display 970 differs from the display 900 shown in FIG. 9A in that the display 970 includes a front substrate 930 that includes a light blocking layer 972. The light blocking layer 972 is formed on a rear-facing surface of the front substrate 930. The light blocking layer 972 has front apertures 976 formed therethrough, which are aligned with corresponding rear apertures 906. Each of the front apertures 976 are sized such that light passing through a corresponding rear aperture 906 that forms a left eye image or a right eye image can pass through the front aperture 976a. Moreover, the light blocking layer 972 can absorb ambient light incident on a front surface of the light blocking layer 972. In this way, the contrast ratio of the display is improved. In some implementations, the size of the apertures 976 formed through the light blocking layer 972 is based, in part, on the size of the rear aperture 906, the distance between the rear substrate 902 and the light blocking layer 972 and the travel distance and size of the display shutters 920 and the parallax barrier shutters 940.

FIG. 9F shows an example top view of a portion of the display 900. The portion of the display 900 shown in FIG. 9F corresponds to the portion of the display 900 as shown in FIG. 9E. It should be noted that the top view corresponds to a view normal to the front substrate 930 of the display 900. As shown in FIG. 9F, the front surface of the front substrate 930 is shown. Since the front substrate 930 is transparent, the light blocking layer 972 formed on the rear surface of the front substrate 930 can be seen.

As shown in FIG. 9E, the center of the front aperture 976a and the center of the first display shutter aperture 928a of the display shutter 920a are substantially aligned with the center of the rear aperture 906a. Further, the first parallax barrier shutter 940a is offset relative to the center of the center of the front aperture 976a, the display shutter aperture 928a and the center of the rear aperture 906a. In particular, the first parallax barrier shutter 940a is offset towards the left side of the rear aperture 906a such that the right light blocking portion 946 blocks the right side of the underlying rear aperture 906a, while the left light blocking portion 944 overlaps a light blocking portion of the underlying first display shutter 920a.

As such, when the first front aperture 976a is viewed normal to the front substrate 930 as shown in FIG. 9F, a front facing surface of a portion of the light blocking portion of the parallax barrier shutter 940a and the parallax barrier shutter aperture 948a can be seen. Through the parallax barrier shutter aperture 948a, a front facing surface of a portion of the light blocking portion of the display shutter 920a is visible. Assuming that the display shutter aperture 928a is slightly larger than the underlying rear aperture 906a, a portion of the light blocking layer 904 that defines the right side of the rear aperture 906a is also visible. In this way, when the first parallax barrier shutter 940a is in the left eye image state and the first display shutter 920a is in a light transmissive state, a portion of the first display shutter 920a, a portion of the underlying light blocking layer 904 of the rear substrate 902 and a portion of the first rear aperture 906a are visible. The ratio of the widths of the portions of the first display shutter 920a, the light blocking layer 904 and the first rear aperture 906a that are visible through the first parallax barrier shutter aperture 948a depends on the size of the first parallax barrier shutter aperture 948a, the amount of overlap between the left light blocking portion 944 of the first parallax barrier shutter 940a and the rear aperture 906a, the width of the first display shutter aperture 928a and the width of the first rear aperture 906a.

As further shown in FIG. 9E, the center of the second front aperture 976b and the center of the second display shutter aperture 928b of the second display shutter 920b are aligned with the center of the second rear aperture 906b. Further, the second parallax barrier shutter 940b is offset relative to the center of the second front aperture 976b, the center of the second display shutter aperture 928b and the center of the second rear aperture 906b. In particular, the second parallax barrier shutter 940b is offset towards the right side of the second rear aperture 906b such that the left light blocking portion 944 blocks the left side of the underlying rear aperture 906b, while the right light blocking portion 946 overlaps a light blocking portion of the underlying second display shutter 920b.

As such, when the second front aperture 976b is viewed normal to the front substrate 930 as shown in FIG. 9F, a front facing surface of a portion of the light blocking portion of the parallax barrier shutter 940b and the second parallax barrier shutter aperture 948b can be seen. Through the second parallax barrier shutter aperture 948b, a front facing surface of a portion of the light blocking portion of the second display shutter 920b is visible. Assuming that the second display shutter aperture 928b is slightly larger than the underlying rear aperture 906b, a portion of the light blocking layer 904 that defines the right side of the rear aperture 906b is also visible. In this way, when the second parallax barrier shutter 940b is in the right eye image state and the display shutter 920 is in a light transmissive state, a portion of the display shutter 920, a portion of the underlying light blocking layer 904 of the rear substrate 902 and a portion of the rear aperture 906b are visible. The ratio of the widths of the portions of the second display shutter 920b, the light blocking layer 904 and the rear aperture 906b that are visible through the second parallax barrier shutter aperture 948b depends on the size of the parallax barrier shutter aperture 948b, the amount of overlap between the right light blocking portion 946 of the parallax barrier shutter 940b and the second rear aperture 906b, the width of the second display shutter aperture 928b and the width of the second rear aperture 906b.

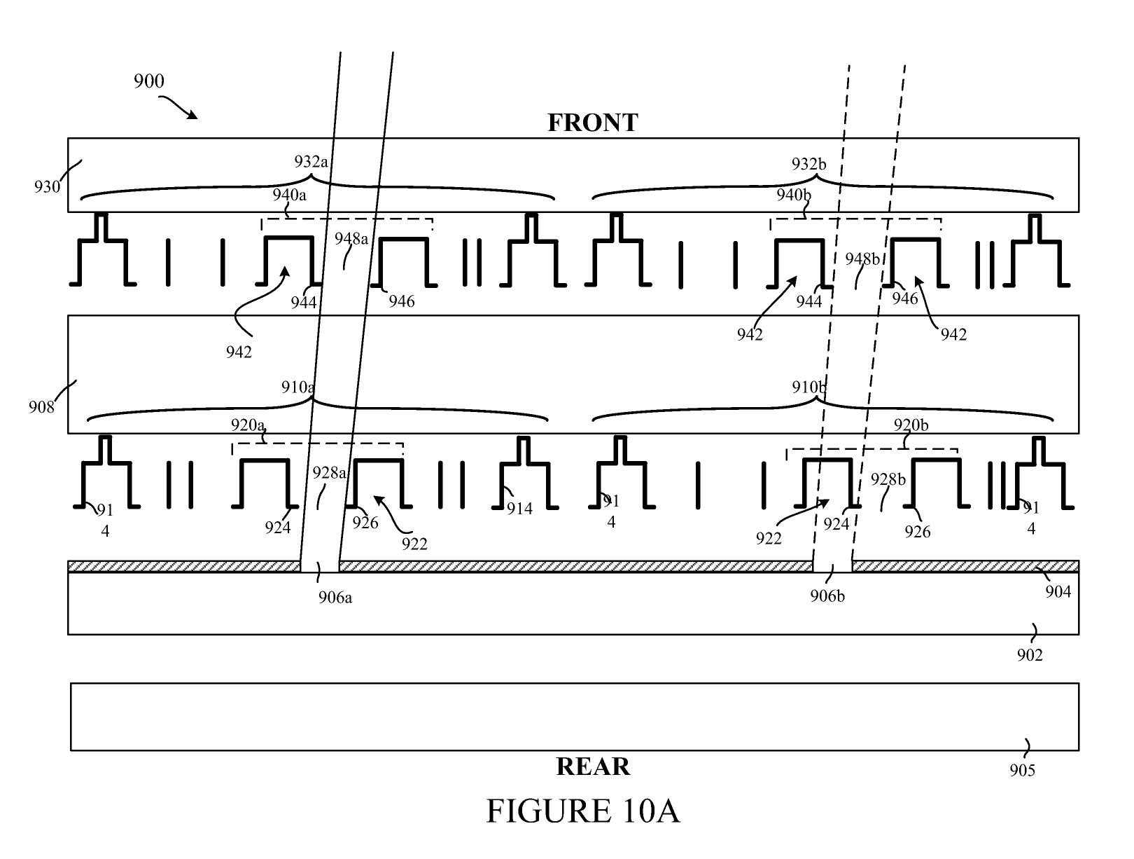

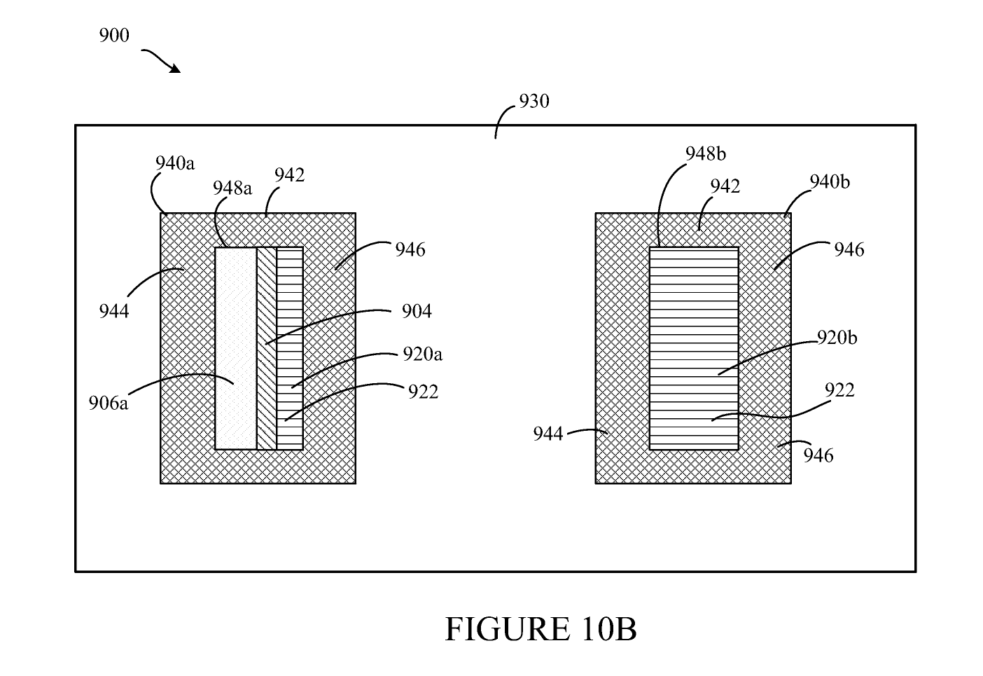

FIG. 10A shows an example cross-sectional view of the display 900 of FIG. 9A. The display 900 shown in FIG. 10A is structurally identical to the display 900 shown in FIG. 9A. The display 900 shown in FIG. 10A is also configured in a manner substantially similar to the display 900 shown in FIG. 9A but differs from the display 900 shown in FIG. 9A in that instead of being in the light transmissive state, the second display shutter 920b is in the light blocking state. That is, the light blocking portion 922 of the second display shutter 920b is positioned over the rear aperture 906b. As such, light from the backlight 905 that passes through the rear aperture 906b is blocked by the light blocking portion 922 of the second display shutter 920.

FIG. 10B shows an example top view of a portion of the display 900. The portion of the display 900 shown in FIG. 10B corresponds to the portion of the display 900 as shown in FIG. 10A. As described above with respect to FIG. 10A, the display 900 is substantially similar to the display 900 shown in FIG. 9A except that instead of being in the light transmissive state, the second display shutter 920 is in the light blocking state.

As shown in FIG. 10B, the front surface of the front substrate 930 when viewed from a position normal to the display 900 is shown. Since the front substrate 930 is transparent, the first parallax barrier shutter 940a and the second parallax barrier shutter 940b formed on the rear surface of the front substrate 930 can be seen. The view through the first parallax barrier shutter aperture 948a of the first parallax barrier shutter 940a is similar to the view of the first parallax barrier shutter aperture 948a of the first parallax barrier shutter 940a shown in FIG. 9C, which corresponds to the configuration of the display 900 shown in FIG. 9A. This is because the portion of the display 900 shown in FIG. 10A that corresponds to the first parallax barrier shutter 940a and the first display shutter 920a has the same configuration as the portion of the display 900 shown in FIG. 10A that corresponds to the first parallax barrier shutter 940 and the first display shutter 920 shown in FIG. 9A.

In contrast, the view through the second parallax barrier shutter aperture 948b shown in FIG. 10B is different from the view through the second parallax barrier shutter aperture 948b shown in FIG. 9C. The view through the second parallax barrier shutter aperture 948b shown in FIG. 10B includes the front surface of the light blocking portion 922 of the second display shutter 920b. As described above, when the display shutter 920b is driven to a light blocking state, the light blocking portion 922 of the display shutter 920b overlaps the underlying rear aperture 906b. In some implementations, the view through the second parallax barrier shutter aperture 948b shown in FIG. 10B may include the light blocking portion 922 of the display shutter 920b and a portion of the light blocking layer 904.

As described above, in some implementations, the parallax barrier shutter assemblies are coupled to a common voltage interconnect such that all of the parallax barrier shutters can readily be driven to the same image state at the same time. In some implementations, one or more of the shutter assemblies in the array of parallax barrier shutters may be independently controlled. As a result, some of the parallax barrier shutters can be driven to the left eye image state, while other parallax barrier shutters can be driven to the right eye image state. In this way, the display may be configured to display portions of both a left eye image and a right eye image at the same first time instance. During a second time instance subsequent to the first time instance, the display may be configured to reverse the states of the respective parallax barrier shutters and output data corresponding to the remaining portions of the left eye and right eye images to the corresponding display elements. As a result, at the second time instance, the display elements displaying portions of the left eye image during the first time instance now display the remaining portions of the right eye image, and the display elements displaying portions of the right eye image during the first time instance now display the remaining portions of the left eye image.

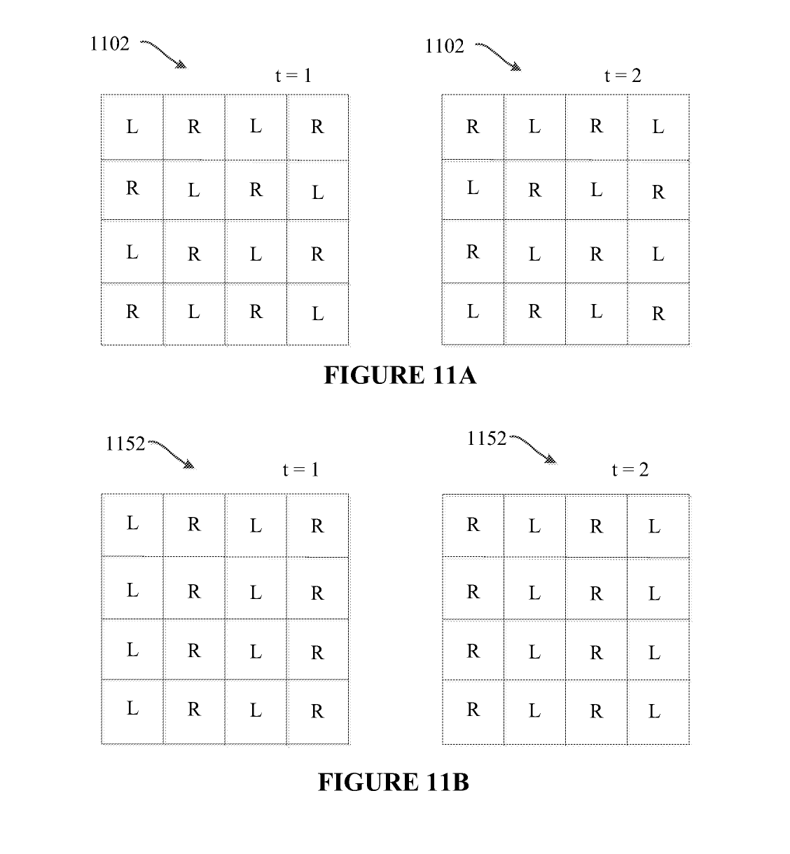

FIG. 11A shows an example portion of a display 1102 at two points in time. The display 1102 operates according to a spatial temporal multiplexing process to form 3D images. The display 1102 includes an array of display elements. Each display element has a corresponding parallax barrier shutter. The grid shown in FIG. 11A represents an array of these parallax barrier shutters. Each parallax barrier shutter in FIG. 11A is labeled with an L or R. The label indicates whether the parallax barrier shutter in a state in which the light passing by or through the parallax barrier shutter contributes to a left eye image or a right eye image. As shown, at a time t=1, a first set of parallax barrier shutters in the portion of the display 1102 are in a state such that light passing by or through the parallax barrier shutter contributes to a left eye image, while a second set of parallax barrier shutters in the portion of the display 1102 are in a state such that light passing by or through the parallax barrier shutter contributes to a right eye image. At time t=2, the first set of parallax barrier shutters in the portion of the display 1102 are in a state such that light passing by or through the parallax barrier shutter contributes to a right eye image, while the second set of parallax barrier shutters in the portion of the display 1102 are in a state such that light passing by or through the parallax barrier shutter contributes to a left eye image. In some implementations, the parallax barrier shutters can be assigned to alternate between a left eye image state and a right eye image state. In this way, a display controller can temporally multiplex left and right eye images on the display 1102 using the parallax barrier shutters of the display 1102. In the display 1102, the first set of parallax barrier shutters and the second set of parallax barrier are arranged in a “checkerboard” fashion, i.e., alternating every row and column.

FIG. 11B shows an example portion of a display 1152 at two points in time. The display 1152 is identical to the display 1102, other than that the first set of parallax barrier shutters and the second set of parallax barrier shutters alternate every column, instead of in a checkerboard fashion. Accordingly, as shown in FIG. 11B, at time t=1, all of the parallax barrier shutters in odd numbered columns of the display 1152 are in a left eye state and all parallax barrier shutters in the even columns are in a right eye state. At time t=2, the states of all of the parallax barrier shutters are reversed. Similarly, in other implementations, the states of the parallax barrier shutters may alternate every row, or every n rows or columns, or in any other suitable pattern.

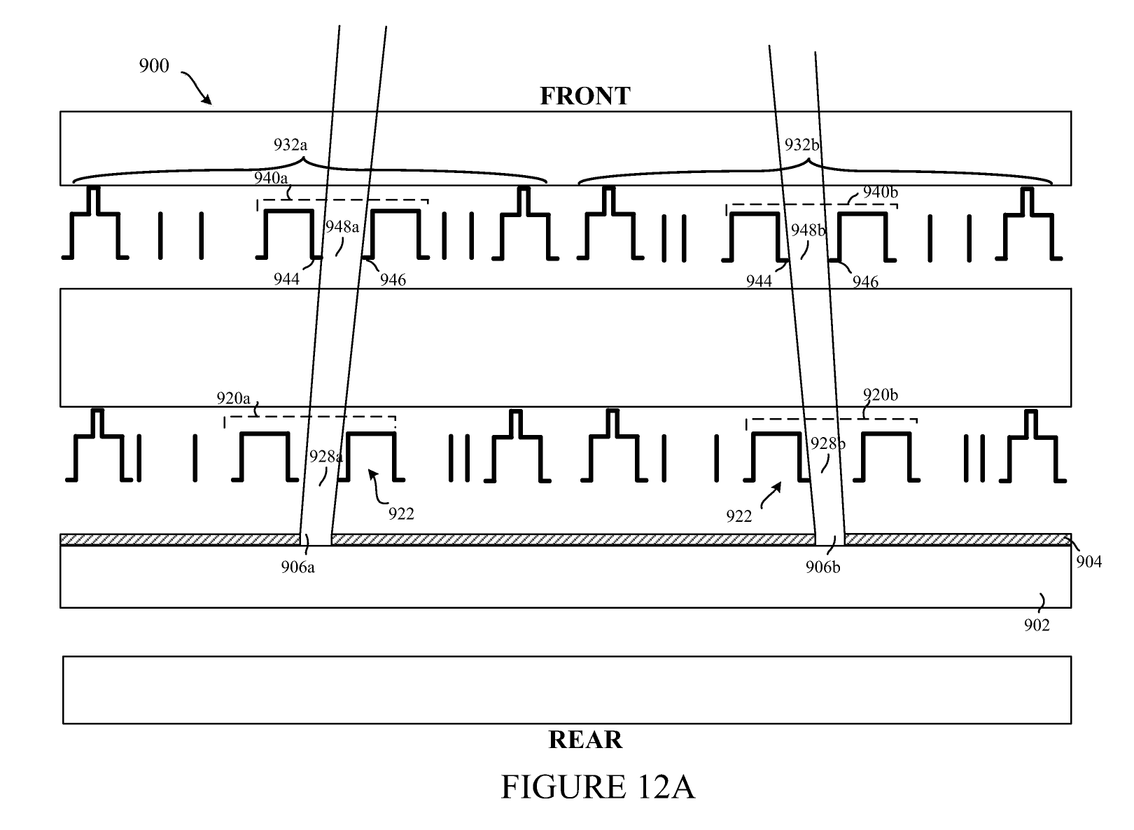

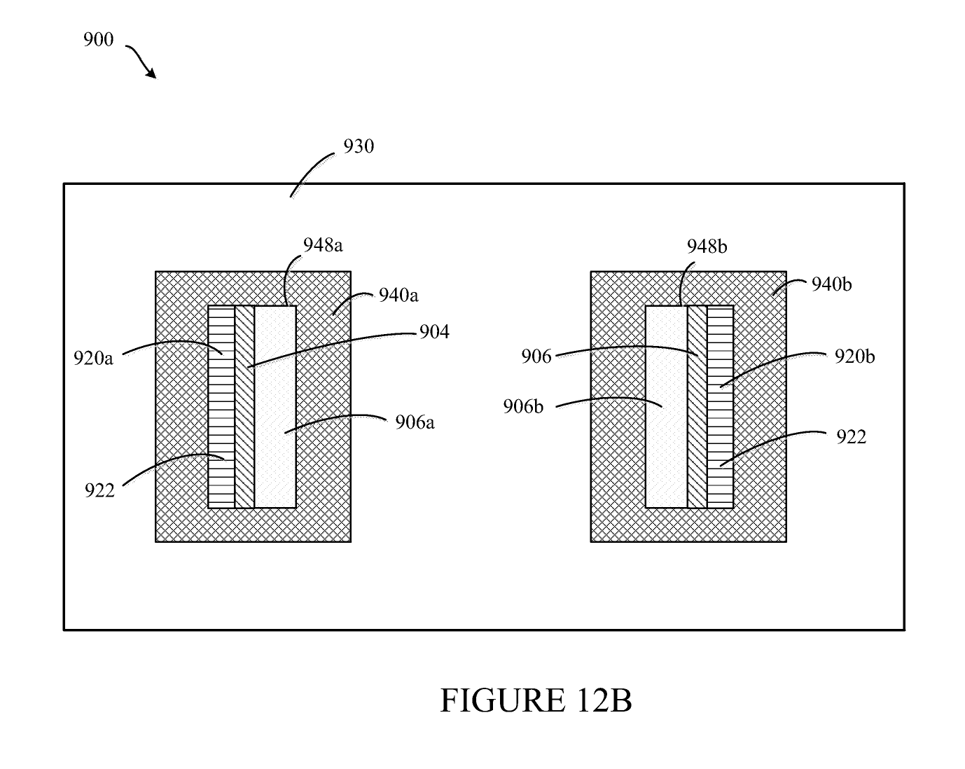

FIG. 12A shows a cross-sectional view of an example display 900. The display 900 is structurally identical to the display 900 shown in FIGS. 9A and 9B. The display 900 shown in FIG. 12A only differs from the display 900 shown in FIGS. 9A and 9B in that the first parallax barrier shutter 940a and the second parallax barrier shutter 940b are independently controlled, similar to as shown in FIGS. 11A and 11B. In some implementations, each of the first and second parallax barrier shutters 940a and 940b may be coupled to an independent voltage source. In some other implementations, the display may include logic associated with each shutter assembly to differentially control a voltage output by a single voltage source. In either case, at a given first time instance, the first parallax barrier shutter 940a may be driven to a right eye image state, while the second parallax barrier shutter 940b may be driven to a left eye image state as is shown in FIG. 12A. At a given second time instance, the first parallax barrier shutter 940a can be driven to a left eye image state, while the second parallax barrier shutter 940b can be driven to a right eye image state.

FIG. 12B shows an example top view of a portion of the display 900. The portion of the display 900 shown in FIG. 12B corresponds to the portion of the display 900 as shown in FIG. 12A. As described above with respect to FIG. 12A, the first parallax barrier shutter 940a is in the right eye image state such that the light passing through the first parallax barrier shutter aperture 944a has an angular distribution weighted more heavily towards the right eye. The second parallax barrier shutter 940b is in the left eye image state such that the light passing through the second parallax barrier shutter aperture 944b has an angular distribution weighted more heavily towards the left eye.

As shown in FIG. 12B, similar to the display 900 shown in FIG. 9C, the front surface of the front substrate 930 when viewed from a position normal to the display 900 is shown. Since the front substrate 930 is transparent, the first parallax barrier shutter 940a and the second parallax barrier shutter 940b formed on the rear surface of the front substrate 930 can be seen. The first parallax barrier shutter 940a includes the light blocking portion 942 having the left light blocking portion 944 and the right light blocking portion 946 that together define the parallax barrier shutter aperture 944a.

As shown in FIG. 12A, the center of the display shutter aperture 928a of the first display shutter 920a is aligned with the center of the first rear aperture 906a. Further, the first parallax barrier shutter 940a is offset relative to the center of the first display shutter aperture 928a and the center of the rear aperture 906a. In particular, the parallax barrier shutter 940a is offset towards the right side of the first rear aperture 906a such that the left light blocking portion 944 blocks the left side of the underlying rear aperture 906a, while the right light blocking portion 946 overlaps a light blocking portion 922 of the underlying display shutter 920. This configuration is identical to the configuration of the portion of the display 900 shown in FIG. 9A that corresponds to first parallax barrier shutter 940a, the first display shutter 920a and the underlying first rear aperture 906a.

As such, when the first parallax barrier shutter aperture 944a is viewed normal to the front substrate 930 as shown in FIG. 12B, the view is identical to the view through the first parallax barrier shutter aperture 948a shown in FIG. 9C. As previously described with respect to FIG. 9C, when the parallax barrier shutter 940a is in the right eye image state and the first display shutter 920a is in a light transmissive state, a portion of the first display shutter 920a, a portion of the underlying light blocking layer 904 of the rear substrate 902 and a portion of the rear aperture 906 are visible.

As further shown in FIG. 12A, the center of the second display shutter aperture 928b of the second display shutter 920b is aligned with the center of the second rear aperture 906b. Further, the second parallax barrier shutter 940b is offset relative to the center of the second display shutter aperture 928b and the center of the second rear aperture 906b. In particular, the second parallax barrier shutter 940b is offset towards the left side of the second rear aperture 906b such that the right light blocking portion 946 blocks the right side of the underlying rear aperture 906b, while the left light blocking portion 944 overlaps a light blocking portion of the underlying second display shutter 920b.

As such, when the second parallax barrier shutter aperture 944b is viewed normal to the front substrate 930 as shown in FIG. 12B, the view is identical to the view through the second parallax barrier shutter aperture 948b shown in FIG. 9D. As previously described with respect to FIG. 9D, when the second parallax barrier shutter 940b is in the left eye image state and the second display shutter 920b is in a light transmissive state, a portion of the second display shutter 920b, a portion of the underlying light blocking layer 904 of the rear substrate 902 and a portion of the second rear aperture 906b are visible.

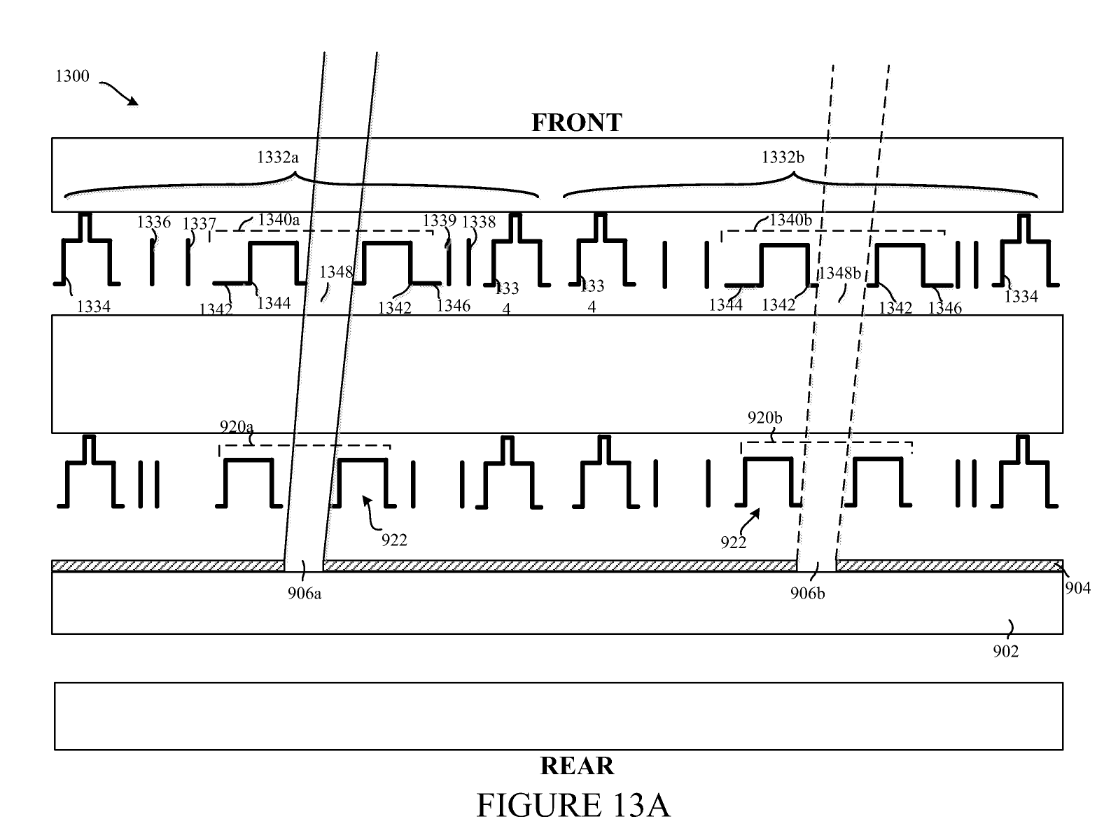

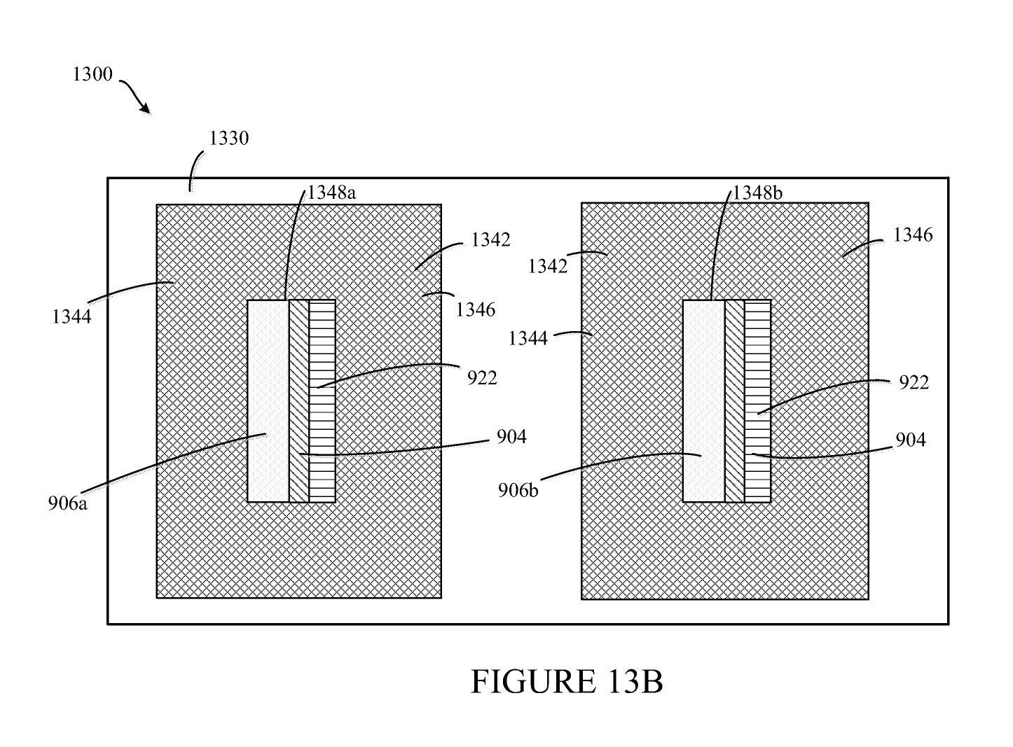

In some implementations, a display apparatus may include a cover plate that forms the front of the display apparatus. For example, the display apparatus 500 shown in FIG. 5A includes a cover plate 522. As described above, the rear side of cover plate 522 can be covered with a light blocking layer 524 to increase contrast. In some implementations that incorporate the parallax barrier shutters, the front substrate of the display does not include a light absorbing layer. Rather, the front surfaces of the parallax barrier shutters are coated with light absorbing material such that the parallax barrier shutters collectively serve as a front light absorbing layer. However, in some implementations, the total size of the front surfaces of all the parallax barrier shutters is relative small compared to the overall size of the front substrate. As such, there is a possibility that light from the backlight may leak out of the display through the regions beneath the front substrate that are not occupied by the front surfaces of the parallax barrier shutters. Further, ambient light from outside the display may reflect off surfaces within the display other than the front surfaces of the parallax barrier shutters. As such, in some displays, the parallax barrier shutters may be designed to include extended light blocking portions having light absorbing front surfaces. An example of such a display is shown in FIG. 13.

FIG. 13A shows a cross-sectional view of an example display 1300. The display 1300 is substantially similar to the display 900 shown in FIGS. 9A and 9B. The display 1300 only differs from the display 900 shown in FIGS. 9A and 9B in that the first parallax barrier shutter 1340a and the second parallax barrier shutter 1340b have extended light blocking portions 1342. Otherwise, the display elements and the parallax barrier shutter assemblies of the display 1300 are in a configuration that is identical to the configuration of the display elements and the parallax barrier shutter assemblies of the display 900 shown in FIG. 9A.

The first parallax barrier shutter 1340a includes the light blocking portion 1342 through which a parallax barrier shutter aperture 1340a is formed. The light blocking portion 1342 includes a left light blocking portion 1344 and a right light blocking portion 1346 that together define the parallax barrier shutter aperture 1340a. In contrast to the left light blocking portion 944 and a right light blocking portion 946 shown in FIG. 9A, the left light blocking portion 1344 and a right light blocking portion 1343 extend along a horizontal plane parallel to the underlying rear substrate 902.

FIG. 13B shows an example top view of a portion of the display 1300. The portion of the display 1300 shown in FIG. 13B corresponds to the portion of the display 1300 as shown in FIG. 13A. As described above with respect to FIG. 13A, the display elements and the parallax barrier shutter assemblies of the display 1300 are in a configuration that is identical to the configuration of the display elements and the parallax barrier shutter assemblies of the display 900 shown in FIG. 9A. As such, the views through the first parallax barrier shutter aperture 1344a and the second parallax barrier shutter aperture 1344b are identical to the views through the first parallax barrier shutter aperture 948a and the second parallax barrier shutter aperture 948b shown in FIG. 9C.

The display 1300 shown in FIG. 13B, however, differs from the display 900 shown in FIG. 9C in that the light blocking portions of the parallax barrier shutters 1340a and 1340b are much larger than the light blocking portions of the parallax barrier shutters 940a and 940b shown in FIG. 9C. This increase in size of the light blocking portions 1342 is attributable to the extended light blocking portions of the parallax barrier shutters 1340a and 1340b. As such, the overall ratio of the light blocking portion relative to the overall surface area of the front substrate is larger. This results in an improved contrast ratio as the amount of light leakage from within the display is reduced and the amount of ambient light reflected is also reduced.

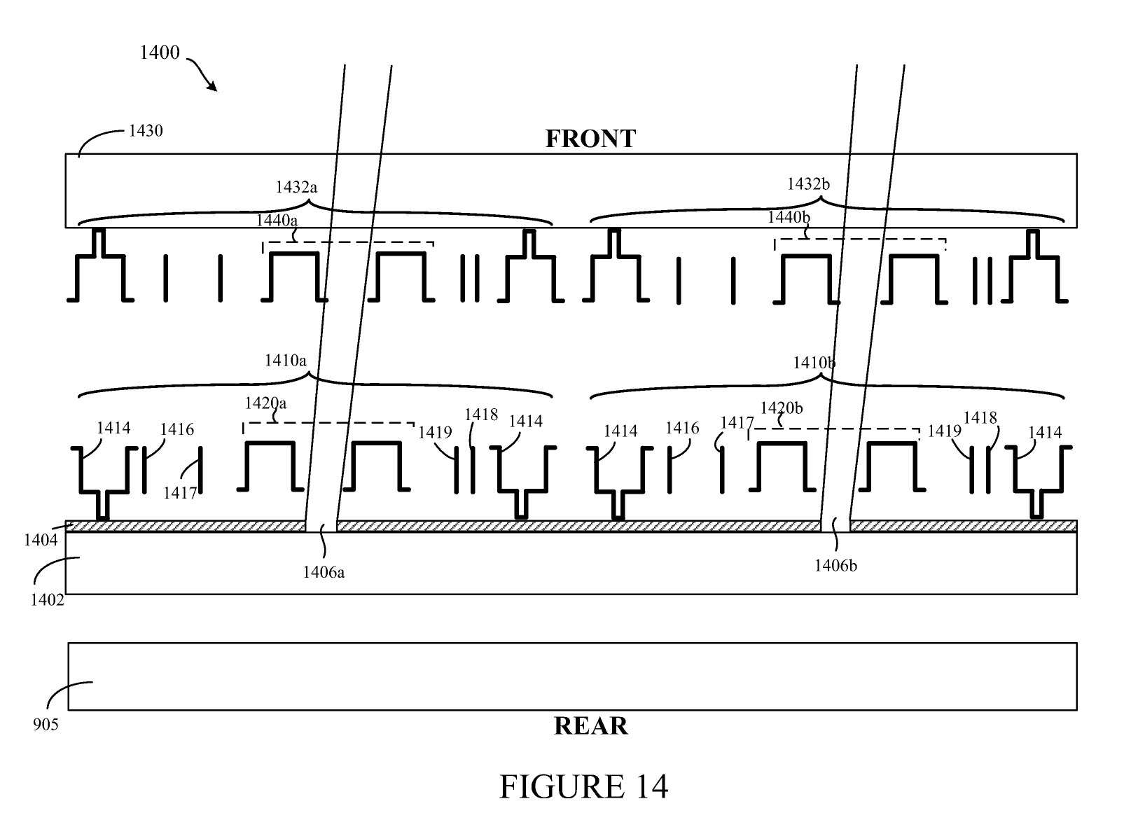

FIG. 14 shows a cross-sectional view of a another example display 1400. The display 1400 is substantially similar to the display 900 shown in FIG. 9A.

The display 1400 includes a rear substrate 1402 on which a light blocking layer 1404 is formed. A plurality of rear apertures including a first rear aperture 906a and a second rear aperture 906b (generally rear aperture 906) are formed through the light blocking layer 1404. The substrate 1402 also is referred to as an aperture layer 1402.

The display 1400 also includes a plurality of display elements, including a first display element 1410a and a second display element 1410b. The first and second display elements 1410a and 1410b, in some implementations, are shutter assemblies. The first display element 1410a and a second display element 1410b are formed on the rear substrate and are supported over the underlying aperture layer 1402 by a pair of anchors 1414. Displays in which the display elements are formed on a rear substrate facing towards the front of the display are referred to as having a MEMS up configuration. Similar to the first display element 910a and a second display element 910b shown in FIG. 9A, each of the first display element 1410a and the second display element 1410b also includes a first drive electrode 1416 and a first load electrode 1417 that form a first actuator, a second drive electrode 1418 and a second load electrode 1419 that form a second actuator, and a display shutter 1420a or 1420b that is configured to be driven by the first and second actuators.

A front substrate 1430 is disposed over the rear substrate 1402. A first parallax barrier shutter assembly 1432a and a second parallax barrier shutter assembly 1432b are formed on a rear surface of the front substrate 1432 facing the rear substrate 1402. The first parallax barrier shutter assembly 1432a and a second parallax barrier shutter assembly 1432b correspond to the display assemblies formed on the rear substrate and the underlying first parallax barrier shutter assembly 1432a and the second parallax barrier shutter assembly 1432b are substantially similar to the first parallax barrier shutter assembly 932a and the second parallax barrier shutter assembly 932b shown in FIG. 9A.

The manner in which this display 1400 forms 3D images is identical to the manner in which the display 900 shown in FIG. 9A forms 3D image. However, in this implementation, the display only includes two substrates. As a result, a MEMS up display incorporating parallax barrier shutters, as shown in FIG. 14, can have a thinner footprint than a MEMS down display, such as the displays 900 shown in FIGS. 9A, 9B, 10A and 12A since a MEMS down display includes three substrates, namely the rear substrate 902, the modulator substrate 908 and the front substrate 930.

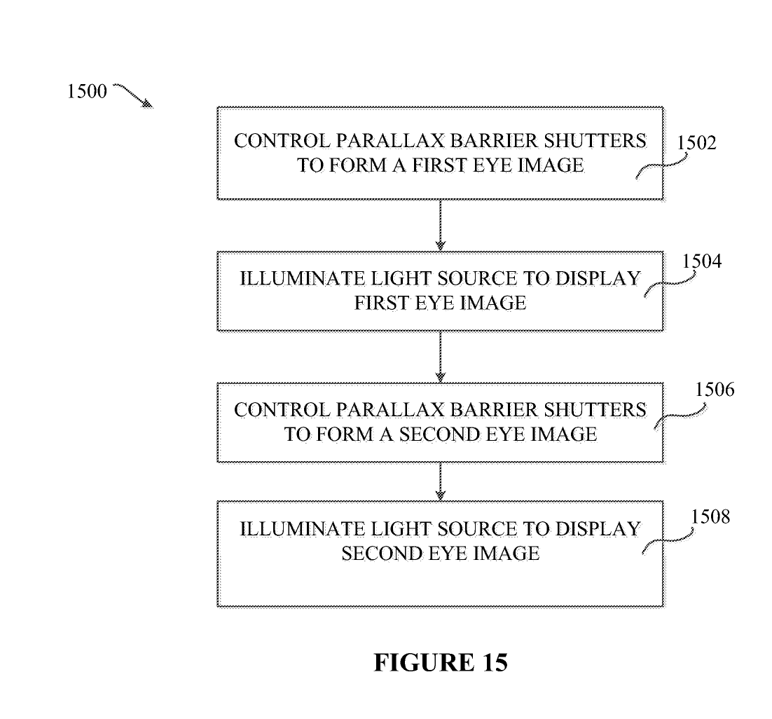

FIG. 15 shows an example flow diagram of a temporal multiplexing display process 1500 by which a controller can display 3D images. The display process 1500 begins with controlling a first set of parallax barrier shutters such that light passing by or through the first set of parallax barrier shutters forms a first image (stage 1502). A light source is illuminated to display the first eye image (stage 1504). The same set of parallax barrier shutters is controlled such that light passing by or through the first set of parallax barrier shutters forms a second eye image (stage 1506), and the light source is illuminated to display the second eye image (stage 1508).

As described above, the display process 1500 begins with controlling a set of parallax barrier shutters (stage 1502) such that light passing by or through the first set of parallax barrier shutters forms a first eye image. The first eye image has an angular distribution of light weighted towards a first eye of a viewer. The controller can cause the parallax barrier shutters to be driven into a first set of states determined based on input data associated with the first eye image. In some implementations, the parallax barrier shutters are formed from shutter-based MEMS light modulators.

Upon controlling the array of parallax barrier shutters to their desired states (stage 1502), the controller illuminates one or more light sources to display the first eye image (stage 1504). Light from the light source, such as a backlight, passes by or through the respective apertures of the corresponding parallax barrier shutters to display a first eye image. The light forming the first eye image has an angular distribution that is weighted more heavily towards a direction of the first eye of the viewer.

The controller also controls the same set of parallax barrier shutters such that light passing by or through the first set of parallax barrier shutters forms a second eye image (stage 1506). The second eye image has an angular distribution of light weighted more heavily towards a second eye of the viewer. The controller causes the parallax barrier shutters to be driven into a second set of states determined based on the input data associated with the second image.

Upon controlling the same set of parallax barrier shutters into their desired states (stage 1506), the controller can illuminate one or more light sources to display the second eye image (stage 1508). Light from the light source passes by or through the respective apertures of the corresponding parallax barrier shutters to display the second image. The light forming the second image has an angular distribution that is weighted more heavily towards a direction of the second eye of the viewer. Using this process 1500, a controller can generate 3D images on a display apparatus having an array of parallax barrier shutters.

In some other implementations, the display can implement a spatial multiplexing 3D display process in which the light source can be illuminated to form the first eye image and the second eye image at the same time using alternating light modulators.

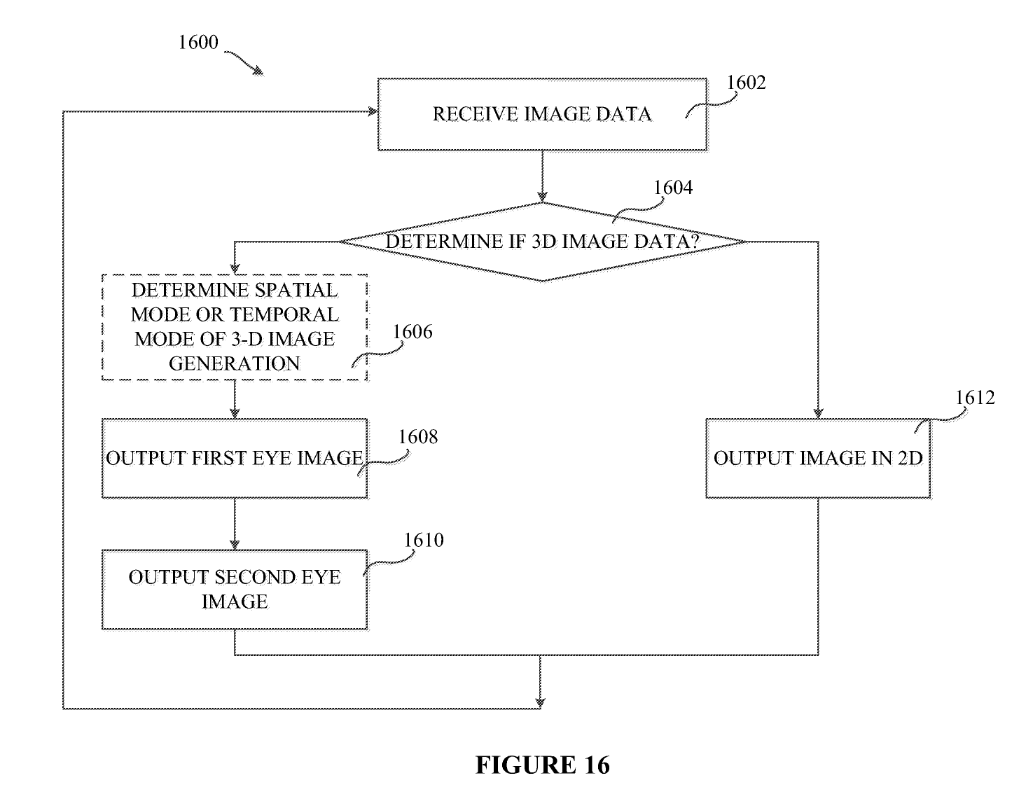

FIG. 16 shows an example flow diagram of a display process 1600 for displaying images. The display process 1600 begins with receiving image data (stage 1602). A determination whether the image data is 3D image data is made (stage 1604). If the image data is 3D image data, a first eye image is output (stage 1608) and a second eye image is output (stage 1610) to form a stereoscopic image. For some display apparatus that can generate 3D images using either spatial multiplexing or temporal multiplexing, prior to generating the first eye image (stage 1608) and the second eye image (1610), the display apparatus makes a determination whether to use spatial multiplexing or temporal multiplexing (stage 1606). If the image data is not 3D image data, both the first eye image and the second eye image output identical images to form a 2D image (stage 1612).

As described above, the display process 1600 begins with a display apparatus receiving image data (stage 1600) to be displayed. The display apparatus determines if the image data is 3D (stage 1604). The image data may correspond to 2D images or 3D images. In some implementations, the image data may include metadata or some other form of identification that identifies the image data as being 2D or 3D. The display apparatus can determine that the image data is 3D by evaluating this metadata. In some other implementations, the display apparatus can receive separate data from a host processor indicating that the image data is 3D. For example, the host processor 122 of the host device 120 shown in FIG. 1B, can send a data signal to the controller 134 of the display apparatus 128 indicating that the image data is 3D.

Some display apparatus can generate 3D images using either spatial multiplexing or temporal multiplexing. An example of such display apparatus is the display apparatus 1200 of FIG. 12A. Thus, if it is determined that a received image is a 3D image at stage 1604, such a display apparatus determines whether to use spatial multiplexing or temporal multiplexing (stage 1606) to generate the 3D image. One example factor that can influence the type of multiplexing to utilize includes the frame rate associated with a video incorporating the image being displayed. Images in a video having a higher frame rate may be more suitable for display using spatial multiplexing. Images in videos having a lower frame rate may be more suitable for display using temporal multiplexing for display. Another factor that can be considered is the level of complexity of the image. If the image has a high level of variation or fine details, temporal multiplexing may be more suitable. For displays utilizing time division gray scale to generate different colors, a third factor can be the amount of variation in colors in the image. An image having many different but similar colors (for example, having many different hues of red) may be more suitable for display using spatial multiplexing instead of temporal multiplexing. In such cases, time is better spent in presenting the image with an increased number of bitplanes to appropriately display the different colors. In some implementations, the display apparatus can determine to use spatial multiplexing or temporal multiplexing, for example, on a frame by frame basis or once for a single piece of media.

In some implementations, image frames can be displayed at frame rates ranging from about 24 Hz to 240 Hz. In some implementations, the image frames can be displayed at a frame rate of about 60 Hz. In such implementations, each image frame has a frame duration of about 16.6 ms. Accordingly, at a frame rate of 60 Hz, which corresponds to a frame duration of about 16.6 ms, the addressing time and the illumination time for each right eye image and each left eye image can be limited to only about 8.3 ms. In implementations that utilize temporal multiplexing, for example, in which parallax barrier shutters display left eye images and right eye images in an alternating manner, the frame rate at which left eye images and the right eye images are displayed may be twice the total frame rate. As such, to achieve a total frame rate of about 60 Hz, the frame rate at which left eye images and the right eye images are displayed may be about 120 Hz.

In some implementations that utilize spatial multiplexing, in which a left eye image and a right eye image are displayed simultaneously, the frame rates at which the left eye images and the right eye images are displayed may be substantially the same as the total frame rate. For example, if image frames are to be displayed at a frame rate of 60 Hz, the left eye image frames and the right eye image frames can be displayed at a frame rate of 60 Hz.

Assuming the image is a 3D image, the display apparatus outputs a first eye image (stage 1608) and a second eye image (stage 1610). As described above, the first eye image may be formed by displaying light angled towards a first side of the display apparatus and a second eye image may be formed by displaying light angled towards a second side of the display apparatus opposite the first side. In display apparatus that are designed (or have elected) to use spatial multiplexing to generate a 3D images, a first set of light modulators are actuated into states appropriate for forming the first eye image. A second set of light modulators are actuated into states appropriate for the second eye image. In a spatial multiplexing arrangement, the first eye image and the second eye image are typically displayed simultaneously, though in some implementations they also may be displayed sequentially. In a temporal multiplexing arrangement, the first eye image and the second eye image are displayed sequentially since the same light modulators are used to display both the first eye image and the second eye image.

If the image data is not 3D image data (stage 1604), the display apparatus outputs the image in 2D (stage 1612). An image is perceived in 2D if the images perceived by the left eye and the right eye of the viewer are substantially identical. Display apparatus incorporating parallax barrier shutters, such as the display apparatus 900 shown in FIG. 9A, can be configured to display a 2D image by outputting an image with the parallax barrier shutters in the left eye image state followed by outputting the parallax barrier shutters being in the right eye image state. In some implementations, the display elements may not need to be readdressed. Instead, the parallax barrier shutters can be caused to transition states partway through the illumination of an image frame. In this way, both the left eye and the right eye perceive the same image with the same intensity.

In some other implementations, the parallax barrier shutters can be configured to be driven to a neutral image state. When the parallax barrier shutters are in the neutral image state, the parallax barrier shutter apertures are substantially aligned with the corresponding underlying rear apertures. In this way, the light blocking portions of a parallax barrier shutter do not overlap, or evenly overlap, the underlying rear aperture on both sides. As a result, the light passing through the rear apertures passes through the parallax barrier shutter apertures with an angular distribution that is weighted evenly towards the left eye and the right eye of the viewer.

In some implementations, the parallax barrier shutters can be driven to more than three image states. In some such implementations, the parallax barrier shutters can be driven to additional image states in which the amount of overlap between the light blocking portions of the parallax barrier shutters and the underlying rear apertures is greater than the amount of overlap when the parallax barrier shutters are in the neutral image state and less than the amount of overlap when the parallax barrier shutters are in either the left eye image state or the right eye image state. In some such implementations, the parallax barrier shutters can be driven to a particular image state that has a predetermined offset distance that corresponds to a particular viewing distance of the viewer from the front of the display. As such, depending on how far a viewer is from the display, the controller may select a state to which the parallax barrier shutters are driven. The state selected corresponds to the viewing distance of the viewer. The viewing distance may be determined, in some implementations by a sensor incorporated into a display.

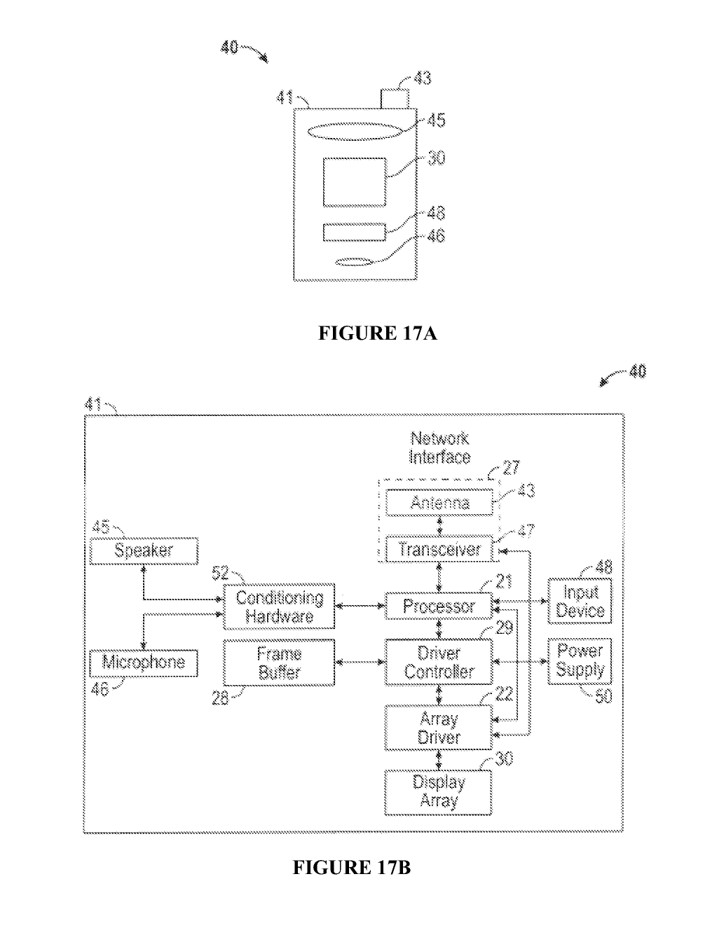

FIGS. 17A and 17B are examples of system block diagrams illustrating a display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, electroluminescent (EL), organic light-emitting diode (OLED), super-twisted nematic liquid crystal display (STN LCD), or thin film transistor (TFT) LCD, or a non-flat-panel display, such as a cathode ray tube (CRT) or other tube device.

The components of the display device 40 are schematically illustrated in FIG. 17A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 17A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 801.11 standard, including IEEE 801.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22, and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as the controller 134 described above with respect to FIG. 1). Additionally, the array driver 22 can be a conventional driver or a bi-stable display driver. Moreover, the display array 30 can be a conventional display array or a bi-stable display array (such as a display including an array of display elements, such as light modulator array 320 depicted in FIG. 3B). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
an array of display elements; and
a plurality of parallax barrier shutters, each parallax barrier shutter corresponding to one of the display elements and configured to be driven into a first state in which an angular distribution of light passing the parallax barrier shutter from the corresponding display element is weighted towards a first side of the apparatus or a second state in which the angular distribution of light passing the parallax barrier shutter from the corresponding display element is weighted towards a second side of the apparatus opposite the first side.

2. The apparatus of claim 1, wherein the display elements have electromechanical structures that are substantially identical to electromechanical structures of the parallax barrier shutters.

3. The apparatus of claim 1, wherein the display elements have structures that are substantially different from structures of the parallax barrier shutters.

4. The apparatus of claim 1, wherein each of the parallax barrier shutters includes an electromechanical system (EMS) shutter.

5. The apparatus of claim 4, further comprising a controller that is configured to cause the EMS shutter of a respective parallax barrier shutter to be driven into the first state by causing a first voltage to be applied to a first actuator coupled to the parallax barrier shutter and to be driven into the second state by causing a second voltage to be applied to a second actuator coupled to the parallax barrier shutter.

6. The apparatus of claim 1, further comprising a controller that is configured to drive, at a first time, a parallax barrier shutter of the plurality of parallax barrier shutters to the first state in conjunction with providing a corresponding display element image data corresponding to a first eye image and to drive, at a second time, the parallax barrier shutter to the second state in conjunction with providing the corresponding display element image data corresponding to a second eye image.

7. The apparatus of claim 1, wherein the plurality of parallax barrier shutters are coupled to a common voltage source such that, at a first time, all of the plurality of parallax barrier shutters are driven to the first state in conjunction with providing the display elements image data corresponding to a first eye image and at a second time, all of the plurality of parallax barrier shutters are driven to the second state in conjunction with providing the display elements image data corresponding to a second eye image.

8. The apparatus of claim 1, further comprising a controller configured to independently drive a first set of the parallax barrier shutters to the first state in conjunction with providing a corresponding set of display elements image data corresponding to a portion of a first eye image and to independently drive a second set of the parallax barrier shutters to the second state in conjunction with providing a corresponding set of display elements image data corresponding to a portion of a second eye image.

9. The apparatus of claim 1, further comprising:
a rear substrate positioned between a backlight and the parallax barrier shutters, the rear substrate having a light blocking layer, which defines a plurality of rear apertures, each of the rear apertures corresponding to one of the parallax barrier shutters; wherein
the parallax barrier shutters further includes light blocking portions, which overlap a first side of the corresponding rear apertures when the parallax barrier shutters are in a first state and overlap a second side opposite the first side of the corresponding rear apertures when the parallax barrier shutters are in a second state.

10. The apparatus of claim 9, wherein the light blocking portions of the parallax barrier shutters overlap the first side of the corresponding rear apertures by a predetermined distance when the parallax barrier shutters are in the first state; and wherein the light blocking portions of the parallax barrier shutters overlap the second side of the corresponding rear apertures by the same predetermined distance when the parallax barrier shutters are in the second state.

11. The apparatus of claim 9, wherein the display elements are formed on the rear substrate and the parallax barrier shutters are formed on a front substrate supported over the rear substrate.

12. The apparatus of claim 1, wherein the display elements are formed on a modulator substrate supported over a rear substrate that is positioned between a backlight and the modulator substrate and having rear apertures formed thereon; and
wherein the parallax barrier shutters are formed on a front substrate supported over the modulator substrate.

13. The apparatus of claim 1, wherein the parallax barrier shutters are coated with a layer of anti-reflective coating.

14. The apparatus of claim 1, wherein the parallax barrier shutters include light blocking portions and parallax barrier shutters apertures formed therethrough; wherein the light blocking portions of a first parallax barrier shutter extend from the parallax barrier shutter aperture of the first parallax barrier shutter to about half the distance between the first parallax barrier shutter aperture and a second parallax barrier shutter aperture of a neighboring parallax barrier shutter.

15. The apparatus of claim 1, further comprising:
a display;
a processor that is configured to communicate with the display, the processor being configured to process image data; and
a memory device that is configured to communicate with the processor.

16. The apparatus of claim 15, further comprising:
a driver circuit configured to send at least one signal to the display; and wherein
the controller further configured to send at least a portion of the image data to the driver circuit.

17. The apparatus of claim 15, further comprising:
an image source module configured to send the image data to the processor, wherein the image source module comprises at least one of a receiver, transceiver, and transmitter.

18. The apparatus of claim 15, further comprising:
an input device configured to receive input data and to communicate the input data to the processor.

19. The apparatus of claim 15, wherein the display elements include electromechanical system (EMS) display elements.

20. The apparatus of claim 15, further comprising:
a first substrate configured to support the array of display elements; and
a second substrate separated from the first substrate.

21. The apparatus of claim 15, wherein at least one of the first substrate, the second substrate and the display elements comprises the light absorbing structure.

22. An apparatus, comprising:
an array of display elements; and
means for limiting the angular distribution of light corresponding to one of the display elements and configured to be driven into a first state in which an angular distribution of light passing the means for limiting the angular distribution of light from the corresponding display element is weighted towards a first side of the apparatus or a second state in which the angular distribution of light passing the means for limiting the angular distribution of light from the corresponding display element is weighted towards a second side of the apparatus opposite the first side.

23. The apparatus of claim 22, further comprising means for driving the means for limiting the angular distribution of light into the first state by causing a first voltage to be applied to a first actuation means coupled to the means for limiting the angular distribution of light and for driving the means for limiting the angular distribution of light into the second state by causing a second voltage to be applied to a second actuation means coupled to the means for limiting the angular distribution of light.

24. The apparatus of claim 22, further comprising means for driving, at a first time, the means for limiting the angular distribution of light to the first state in conjunction with providing a corresponding display element image data corresponding to a first eye image and for driving, at a second time, the means for limiting the angular distribution of light to the second state in conjunction with providing the corresponding display element image data corresponding to a second eye image.

25. The apparatus of claim 22, wherein means for limiting the angular distribution of light is coupled to a common voltage source such that, at a first time, the means for limiting the angular distribution of light are driven to the first state in conjunction with providing the display elements image data corresponding to a first eye image and at a second time, the means for limiting the angular distribution of light are driven to the second state in conjunction with providing the display elements image data corresponding to a second eye image.

26. The apparatus of claim 22, further comprising means for independently driving a first set of the means for limiting the angular distribution of light to the first state in conjunction with providing a corresponding set of display elements image data corresponding to a portion of a first eye image and for independently driving a second set of the means for limiting the angular distribution of light to the second state in conjunction with providing a corresponding set of display elements image data corresponding to a portion of a second eye image.
